(19) United States
(12) Patent Application Publication
(10) Pub. No.: US 2016/0283952 A1
(43) Pub. Date: Sep. 29, 2016

(54) RANKING INFORMATION PROVIDERS

(71) Applicant: Agingo Corporation, Charlotte, NC (US)

(72) Inventor: Jacob HALL, Huntersville, NC (US)

(21) Appl. No.: 15/034,460

(22) PCT Filed: Nov. 3, 2014
(86) PCT No.: PCT/US2014/063641

§ 371 Date: May 4, 2016

Related U.S. Application Data
(60) Provisional application No. 61/899,623, filed on Nov. 4, 2013.

(51) Int. Cl. G06Q 30/02; G06F 17/30

(52) U.S. Cl. CPC G06Q 30/0201; G06F 17/30867; G06F 17/30554; G06F 17/30528; G06F 17/3053

(57) ABSTRACT

A system and method for ranking providers is provided. The method may include ranking information providers based on their focus and trust in specific keyword contexts. The focus trust rank assigned to a specific information provider may be calculated from their focus for a given keyword that is the subject of an information search. A provider's focus trust rank may additionally or alternatively be calculated based on one or more of the total keyword count set by the provider, the number of consumers who trust the provider, matching trust factors, or a measure of a maturity of the provider in a system using the method for ranking and, thus, filtering providers. Consumers may optionally be provided with the ability to apply their personalized list of focused and trusted providers to transform the results of a full text search such that their trusted providers always rank to the top and optionally can trust providers which are returned in the search.

### CROSS-REFERENCE TO RELATED APPLICATION

This application claims the benefit of International Application No. PCT/US2014/063641 filed on Nov. 3, 2014 and U.S. Provisional Patent Application No. 61/899,623 filed on Nov. 4, 2013, each of the entire disclosures being incorporated herein by reference.

### FIELD OF THE DISCLOSURE

The present disclosure relates generally to search query technology that may be used, for example, by a consumer to search the Internet. More particularly, the present disclosure relates to systems, methods, apparatuses, and computer program products for scoring, ranking and filtering information providers, such as for creating digital borders.

### BACKGROUND

In the context of, for example, the Internet, there are many consumers and providers of information. A consumer may be anything that consumes information, services, or media. In contrast, a provider may be anything that provides a service, information, or media. In the context of the Internet, a consumer or provider can be represented with an email address, domain name, or any other suitable identifier. These identifiers often have multiple pages of content with link names associated to them.

Regarding the Internet, there appears to be an ever increasing number of domain names, data volumes, and information security threats. Also increasing are the demand for data mobility, the importance of organizing content, the importance of finding information fast, the need to minimize distractions, and the need to prevent unnecessary data collection. Due to these ongoing changes, it is becoming increasingly important that consumers have a way to navigate information that improves productivity, privacy, and security in a balanced way while providing a way to influence business behavior.

There are presently over 100 million domain names, the majority of which have a plurality of content pages, which can be retrieved in response to a consumer initiated search engine request. In particular, data corresponding to the content pages is transferred between computing devices (e.g., a web domain server and a user computing device) and returned for viewing, at an end-user computing device, when a consumer initiates a search engine request. It is currently estimated that there are over two (2) billion search queries per year. People primarily use search engines to find pages of information when they do not know if it exists or how to retrieve it directly. However, search engines organize content based on an unlimited index of keywords from pages which are not logically prioritized; therefore, search engine results are often irrelevant to the end consumers, and the consumers spend a lot of time browsing.

Consumers have become increasingly aware of search engine rankings being influenced by advertisers who use techniques such as pay SEM (search engine marketing) and/or SEO (search engine optimization) services to be listed at the top of search results. The search engines provide a view of information which is based on paid optimization rather than by topic area. Information searches often result in misinformation due to SEO/SEM tactics which try to increase customer reach.

One of the challenges with any large body of information, especially where similar information such as contact data is repeated across providers, is that each provider establishes its own language to identify content. As a result, it is difficult for consumers to relate data across providers which is not intentionally organized. The best data is usually aggregated by third-parties which also collect and sell personal data for marketing.

The lack of vocabulary consistency across providers often results in a lack of consistent consumer experience with respect to browsing home pages. Present search engines are designed to allow any domain name to assign any number of keywords without a penalty to the provider. As such, when all websites are indexed, it is difficult for consumers to find the correct content because many providers mislead consumers by adding keywords which are not relevant or highly prioritized in hopes that increased visibility will draw a larger audience. As a result, consumers are often frustrated and distracted by irrelevant or misleading search or related results that are not consistent from one interaction to the next or across search or related services. This leads to the consumers having to manually search through irrelevant information which may primarily involve unnecessarily clicking numerous webpage content links and/or navigating through multiple page loads to find information.

The potential misuse and abuse of personal and private data is increasingly becoming an important problem to solve, as it relates to existing search query techniques. Due to the design of the Internet, it is nearly impossible to completely hide all consumer activity. While the consumer and provider interactions are not easily hidden, the amount of data physically collected in present systems is unnecessarily increased due to consumers navigating through third party services and browsing pages unnecessarily. These services, like search engines, are designed to directly or indirectly track consumer's interactions, such as by connecting to less relevant, or even altogether irrelevant providers that are returned in search or related results.

Another significant problem with current search query technology is that current methods for searching primarily benefit businesses that have a large and significant marketing budget to optimize the search engines and marketing venues in their favor. As a result, it is becoming increasingly difficult for small and medium size companies to be competitive due to their smaller advertising budgets and the relatively new consumer habit of searching the Internet before making a purchase. In other words, the current search algorithms are designed to reward businesses which sell a wide range of products at the expense of businesses having a more dedicated focus or specialization in a smaller range of products or services.

It is desirable for there to be a way to rank and filter providers in a manner that provides a new balance of properties.

### BRIEF SUMMARY

One aspect of this disclosure is the provision of a computer-implemented method for at least scoring a subset of information providers, wherein the subset of information providers is a subset of a plurality of information providers, a set of one or more keywords is associated with each information provider of the subset of information providers, and the computer-implemented method may comprise: receiving at least one keyword; identifying the subset of information providers from the plurality of information providers, wherein for each information provider of the subset of information providers, the set of one or more keywords associated with the information provider includes the at least one keyword; and determining at least one score for each information provider of the subset of information providers, wherein the determining of the at least one score may be comprised of determining a number of keywords included in the set of one or more keywords associated with the information provider, and determining a priority value of the at least one keyword in the set of one or more keywords associated with the information provider.

The determining of the priority value may be comprised of determining a position of the at least one keyword in the set of one or more keywords associated with the information provider.

The determining of the priority value of the at least one keyword may be comprised of determining the priority value of the at least one keyword in relation to any other keywords included in the set of one or more keywords associated with the information provider.

The priority value may have been previously established by the information provider.

The receiving of the at least one keyword may be comprised of receiving the at least one keyword from a web browser by way of the Internet, and the subset of information providers may comprise websites.

The identifying of the subset of information providers may be comprised of determining that the at least one keyword is included in the set of one or more keywords of a provider of the subset of information providers.

The determining of the score for the information provider may further comprise performing a mathematical operation upon a plurality of operands, and the plurality of operands may comprise the number of keywords and the priority value.

The method may further comprise ranking the subset of information providers based at least upon the scores.

The determining of the at least one score may be comprised of determining a focus score, and determining a trust score.

The method may further comprise receiving at least one trust factor, wherein the determining of the at least one score may be further comprised of determining a match between the at least one trust factor and an attribute of the information provider.

The method may further comprise receiving a plurality of trust factors, wherein the determining of the at least one score may be further comprised of counting matches between the plurality of trust factors and attributes of the information provider.

The determining of the at least one score may be further comprised of: determining a number of matching trust factors associated with the information provider; determining a trust count associated with the information provider; and performing at least one mathematical operation upon a plurality of operands, wherein the plurality of operands may comprise the number of matching trust factors and the trust count. The performing of the at least one mathematical operation may further comprise weighting at least one operand of the plurality of operands. The weighting may be comprised of multiplying by a weighting coefficient.

Another aspect of this disclosure is the provision of a computer-implemented method for at least scoring a subset of information providers, wherein the subset of information providers is a subset of a plurality of information providers, a set of one or more keywords is associated with each information provider of the subset of information providers, and the computer-implemented method may comprise: receiving at least one keyword; identifying the subset of information providers from the plurality of information providers, wherein for each information provider of the subset of information providers, the set of one or more keywords associated with the information provider includes the at least one keyword; and determining at least one score for each information provider of the subset of information providers, wherein the determining of the at least one score may be comprised of determining a consumer trust factor, and determining whether there is a match between the consumer trust factor and an attribute of the information provider. The determining of the at least one score may be comprised of determining a plurality of consumer trust factors, and counting matches between the plurality of consumer trust factors and attributes of the information provider. The determining of the at least one score may be further comprised of multiplying a number of counted matches by a weighting coefficient.

A further aspect of this disclosure is the provision of a computer-implemented method for at least scoring a subset of information providers, wherein the subset of information providers is a subset of a plurality of information providers, a set of one or more keywords is associated with each information provider of the subset of information providers, and the computer-implemented method may comprise: receiving at least one keyword; identifying the subset of information providers from the plurality of information providers, wherein for each information provider of the subset of information providers, the set of one or more keywords associated with the information provider includes the at least one keyword; and determining at least one score for each information provider of the subset of information providers, wherein the determining of the at least one score may be comprised of determining a trust count associated with the information provider, determining a trust maturity associated with the information provider, and performing at least one mathematical operation upon a plurality of operands, wherein the plurality of operands may comprise at least one of the trust count and the trust maturity. The performing of the at least one mathematical operation may be comprised of multiplying trust count by a weighting coefficient. For any two providers with identical values for trust count, a provider of the two providers with a higher trust maturity may be ranked higher than the provider of the two providers with a lower trust maturity.

Other aspects are also within the scope of this disclosure. For example, one aspect of this disclosure is the provision of an apparatus comprising a processor and a memory storing executable instructions that in response to execution by the processor cause the apparatus to perform various combinations and subcombinations of the above-discussed operations. Another aspect of this disclosure is the provision of a computer-readable storage medium that is non-transitory and has computer-readable program code portions stored therein that, in response to execution by a processor, cause an apparatus to perform various combinations and subcombinations of the above-discussed operations.

The foregoing presents a simplified summary of some aspects of this disclosure in order to provide a basic understanding. The foregoing summary is not an extensive summary of the disclosure and is not intended to identify key or critical elements of the invention or to delineate the scope of the invention. The purpose of the foregoing summary is to present some concepts of this disclosure in a simplified form as a prelude to the more detailed description that is presented later. For example, other aspects will become apparent from the following.

### BRIEF DESCRIPTION OF THE DRAWINGS

Having described some aspects of the disclosure in general terms, reference will now be made to the accompanying drawings, which are for an exemplary embodiment. The drawings are exemplary only, and should not be construed as limiting the invention.

FIG. 1 illustrates a block diagram for providing a high level overview of some aspects of an overall system, in accordance with an example.

FIG. 2 illustrates a flow diagram of a computer-implemented method for determining a focus score or rank for providers, and ranking the providers based upon their score, in accordance with an example.

FIG. 3 illustrates a block diagram including information that may be used, in accordance with an example, for determining a focus score or rank for providers, and transform the ranking of providers based upon their focus, in accordance with an example.

FIG. 4 illustrates a flow diagram of a computer-implemented method of using trust factors as part of a process for scoring and ranking providers, wherein the trust factors may be used to transform a list of providers into a personalized result, in accordance with an example.

FIG. 5 illustrates a block diagram including information that may be used, in accordance with an example, in the scoring and ranking of providers based upon trust factors, wherein trust factors may cause the scoring and ranking to transform the results and be at least partially based upon consumers' personal views.

FIG. 6 illustrates a flow diagram of a computer-implemented method of using trust count and maturity as part of a process for scoring, ranking, and organizing providers, in accordance with an example.

FIG. 7 illustrates a block diagram including information that may be used to rank providers based on the number of consumers and/or providers that trust providers, and their maturity.

FIG. 8 illustrates a flow diagram of a computer-implemented method for transforming a large list of providers into a ranked list of providers which are most focused on a specific keyword context and are the most trusted in the view of a group or individual consumer, in accordance with an example.

FIG. 9 illustrates consumers, providers, keywords and overall ranking based on focus priority, trust factors, and trust priority for keyword contexts, in accordance with an example.

FIG. 10 is an example of a web page that illustrates the ranking of providers for a keyword context, the ability to browse a list of focused providers, enables search of focused list of providers by transforming full text Internet search results so that a consumers trusted providers are always moved to the top, and allows consumers to find new providers to trust, in accordance with an example.

FIG. 11 illustrates a block diagram of an overall system that includes a ranking apparatus in accordance with some embodiments.

FIG. 12 illustrates a block diagram representing a ranking apparatus that comprises a computer system and one or more ranking modules, in accordance with some embodiments.

### DETAILED DESCRIPTION

Exemplary embodiments are described below and illustrated in the accompanying figures, in which like numerals refer to like parts throughout the several views. The embodiments described provide examples and should not be interpreted as limiting the scope of the invention. Other embodiments, and modifications and improvements of the described embodiments, will occur to those skilled in the art and all such other embodiments, modifications and improvements are within the scope of the present invention. For example, the various examples and embodiments of this disclosure may be combined and used together in various combinations and sub-combinations.

One aspect of this disclosure is the provision of systems, methods, apparatuses, and computer program products that may be used in association with the Internet, and that are configured for scoring, ranking and filtering providers based at least in part on factors such as their focus for providing content (“content specialization”) and/or a degree to which they are trusted by consumers. The systems, methods, apparatuses, and computer program products may further provide for using the resultantly scored, ranked and filtered providers to transform search results associated with the providers and or their available content. In accordance with this aspect, features of this disclosure seek to address at least some problems associated with existing search query technologies. As a more specific example, a computer-based Ranking Apparatus of an exemplary embodiment of this disclosure can be configured for ranking providers based on their focus within a specific keyword context and/or relevance of content based on matching Trust Factors. A provider may be defined as any domain name, email address, physical address, phone number, or any other entity with information assigned to it. A Trust Factor may comprise any preference which is quantitatively and/or qualitatively measurable for the purpose of matching between a consumer need and a characteristic of a provider. For example, the Ranking Apparatus may be configured for ranking and, thus, filtering providers' to thereby transform listed search results so as to create a personal view of the Internet for a given consumer. For example, the listed search results may be or includes content and/or advertisement related search results.

For each provider, the Ranking Apparatus may utilize information about the focus and specialization of the provider and/or other attributes of the provider, such as by quantifying a Focus Rank (e.g., focus score) and/or Trust Priority (e.g., trust score), both of which may be mathematically based upon one or more factors. For example, the Focus Rank may be mathematically based upon one or more factors such as the number of keywords used by a provider, and a prioritized set of keywords for a provider. Also for example, the Trust Priority may be mathematically based upon one or more factors such as the number of people who trust a provider, and matching consumer/provider Trust Factors.

For each consumer, the Ranking Apparatus may enable personalized views of the Internet by using a consensus of consumer preferences, such as those derived from feedback from a community of consumers, to reduce the physical bytes of data transferred between computer devices and eliminate distractions from content which is not relevant to the consumers search request. When a consumers' view of the Internet is personalized based on their reasons for trusting specific content or content providers (which may be otherwise referred to herein as “trust factors”), then the physical human input into a computer device is significantly reduced by eliminating typing, clicks, swipes, scrolls, speech, puffs, and touches that are normally performed during searches to find trusted information. In accordance with one example, if a consumer trusts a domain name, upon performing a full text search of the Internet, the search results are transformed by the system such that the consumers' trusted domain name is prioritized by being displayed at the top of any returned search result. Traditionally, a consumer may have to click through multiple pages of search results before locating their trusted providers; however, using the present invention this cumbersome process is unnecessary. Such a method can be particularly helpful when applied to the large numbers of providers on the Internet, across Intranets and/or to those with disabilities

The Ranking Apparatus may use the Domain Name System (DNS), which can provide a unique way to name a provider and to associate the provider with a ranked set of keywords. In accordance with the exemplary embodiment, the ranked keywords which can be associated with a provider may represent a measure of the focus/specialization and ultimately the degree of trust for a provider in a specific context. In accordance with one example, the search results may be customized as a result of prepending a keyword to a specific domain name such as “agingo.com” in which agingo may refer to a ranking provider system, as discussed herein. More particularly, in these examples, “shoes.agingo.com” would return a list of providers that are organized by their focus and trustworthiness in which the focus is associated with the keyword shoes. Further in these examples, the customized search results may be generated by the system (e.g., generated based on provider ranking) and transmitted for display on a web page associated with the domain name of the ranking provider system. Additionally and/or alternatively the customized search results may be displayable on a web page associated with a search engine provided by the ranking system provider or a third-party search engine.

In one aspect of this disclosure, rather than determining information search relevance based solely on how many other websites link to a page, what your friends like, or the anchor tags of the backlinks to the documents, the Ranking Apparatus may rank providers and their associated content based on their focus within a specific keyword context and based on the provider's trust factors relative to a consumer's trust priorities.

The Ranking Apparatus may determine and transform the ranking of a list of providers, or search results, for a specific keyword based at least in part on some combination of one or more of each provider's prioritization of keywords, the number of people who trust the provider, the number of keywords associated with the provider, Trust Factor matches, geo-location, and the list of trusted providers that a limited set of friends may share.

The Ranking Apparatus may rank a provider based at least in part on the provider's specialization, rather than solely based on the content of the documents or an unlimited list of words with which the provider would like consumers to believe their domain or email address is associated. Accordingly, providers may be “rewarded” by consumers for providing a smaller set of keywords that accurately reflects their content focus. This seeks to prevent providers from inappropriately influencing the results purposely for wide data exposure or financial gain (e.g., as may be associated with collecting personal data from consumers).

An aspect of this disclosure is the provision of a computer-implemented method for ranking providers. The computer-implemented method may include obtaining and/or identifying a subset of a plurality of providers, wherein in one example the plurality of providers may comprise the above-mentioned 100 million domain names, the majority of which have a plurality of content pages (e.g., websites) At least some of the providers may be shared amongst multiple consumers. At least some of the providers may have prioritized keywords for their areas of specialization. At least some of the providers may have associated Trust Factors based on a level of trust in the providers by a number of consumers. In some embodiments, some of the providers may have defined Trust Factors. The computer-implemented method may further include receiving a keyword search query from a consumer, such as from a web browser or any other suitable source. The computer-implemented method may additionally include determining a ranked list of providers corresponding to the keyword search query based at least in part on the prioritized keywords and Trust Factors associated with the providers. The computer-implemented method may also include returning the ranked list of providers to the consumer in response to the navigation or search query.

Embodiments disclosed herein may be particularly useful in helping consumers focus on a set of relevant information providers, while interacting with information, by reducing the number of irrelevant information providers returned in an information search. By eliminating irrelevant information providers from search results it reduces the physical transfer of data between computing devices and minimizes human input (e.g., human initiated keyboard, voice, mouse, and touch input) which would normally be required if irrelevant information providers were displayed in the search results requiring consumers to manually read and/or search through multiple pages to eliminate erroneous search results and find pertinent information. In this regard, some embodiments enable consumers to more efficiently navigate the Internet by efficiently organizing providers based on their true focus rather than based on marketing tactics used by providers to manipulate search results in existing information search query techniques. Some embodiments may additionally be particularly useful to small and medium sized businesses who cannot afford to compete with the Internet marketing budgets of larger companies which pay to be highly ranked for keywords which they wish to advertise and associate with their Internet address.

In accordance with an exemplary embodiment of this disclosure, the Ranking Apparatus operates in association with (e.g., has access to) one or more relational databases (“the databases”), wherein a relational database can be represented as a set of tables with rows and columns. For example, respective tables within a relational database may be used to represent information for providers with online maturity, wherein this information may include or be representative of the trust or popularity that consumers have for providers, a prioritized list of keywords for providers, and a list of Trust Factors for providers.

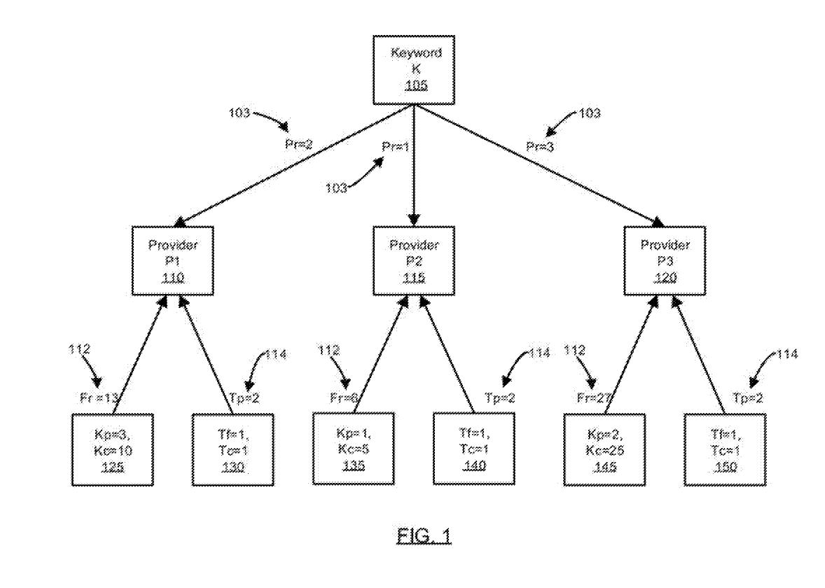

FIG. 1 illustrates a block diagram of some aspects of an overall system, in accordance with one example of the exemplary embodiment, wherein at least some of the blocks of FIG. 1 may be characterized as comprising or schematically representing various data, and at least some of this data may be in the databases associated with (e.g., accessible by) the Ranking Apparatus. For example, block 105 may be characterized as being schematically illustrative of one or more keywords that may be used to set a context or frame of reference for a discussion of the Ranking Apparatus. For example, a keyword represented by block 105 may be one or more keywords received by the Ranking Apparatus from, for example, a web browser of a computerized device of a consumer, as part of a keyword search query directed to the Internet, or the keyword may be received from any other suitable source. Blocks 110, 115, 120 are respectively schematically illustrative of data for at least identifying a plurality or subset of providers P1, P2, P3, and/or groups or sets of keywords established by and/or otherwise associated with the providers. In one example associated with FIG. 1, each of the groups or sets of keywords (that are schematically illustrated by the blocks 110, 115, 120 as being respectively associated with the providers P1, P2, P3) includes the keyword associated with block 105.

Blocks 125, 135, 145 schematically represent focus-related information about the groups or sets of keywords respectively associated with the providers P1, P2, P3. For example, the data associated with blocks 125, 135, 145 includes an indication of the number of keywords, or Keyword Count (“Kc”), for the groups or sets of keywords respectively associated with the providers P1, P2, P3. In addition, for each of the blocks 125, 135, 145, the data associated therewith includes an indication of the priority of, or the Keyword Priority (“Kp”) for, each keyword included in the associated group of keywords. A Focus Rank (“Fr”) 112 for each of the providers P1, P2, P3 may be mathematically based at least upon the Keyword Count and Keyword Priority for the provider, as will be discussed in greater detail below.

Blocks 130, 140, 150 schematically represent trust-related information about the providers P1, P2, P3. For example, the data associated with blocks 130, 140, 150 includes an indication of the number of matching Trust Factors (“Tf”) between a consumer and provider P1, P2, P3, and a Trust Count (“Tc”) which is indicative of relative trust consumers have with the providers. A Trust Priority (“Tp”) 114 (e.g., trust score) for each of the providers P1, P2, P3 may be mathematically based at least upon the number of matching Trust Factors and Trust Priority for the provider, as will be discussed in greater detail below.

As will be discussed in greater detail below, FIG. 1 schematically illustrates relationships between keywords, providers P1, P2, P3, Focus Rank (“Fr”) for each provider, and the Trust Priority (“Tp”) for each provider. For example and referring back to the top of FIG. 1, at block 105 at least one keyword can be provided as input to the Ranking Apparatus by a consumer or application, and the Ranking Apparatus uses the one or more keywords it receives at block 105 to set the focus or context for a query. Examples of keywords could include “shoes”, “flipflops”, “sandals”, or any other word describing an area of focus. Providers P1, P2, P3 are most commonly represented by a domain name (e.g., may comprise a website) and may serve a plurality of content pages through keyword links and HTML. Domain names, email addresses, and phone numbers are just a few examples illustrating how the providers P1, P2, P3 may serve their information to a consumer. Alternatively, an individual consumer or provider P1, P2, P3 can interchangeably serve both roles as it relates to exchanging information. For example, individuals can take on a provider role and offer information to a business. In this regard, a consumer would be thought of as a provider. As such, this overall system can be used to organize people based on focus as well as information providers. Apparatuses and systems of this disclosure may be implemented on servers, desktops, mobile devices or any other suitable devices.

Focus Rank 112 can describe the overall focus of a provider for a specified keyword focus area, wherein the specified keyword focus area is represented by block 105 in FIG. 1. The Focus Rank 112 (e.g., focus score) for a provider may be derived from a mathematical operation based upon a plurality of operands, such as by being the sum of the Keyword Count 125 and Keyword Priority 125 for that provider. For block 125, for the group of keywords for provider P1, the Keyword Count (“Kc”) is equal to 10. For block 125, for the keyword in the group of keywords for the provider P1 that is equal to the keyword of block 105, the Keyword Priority (“Kp”) is equal to 3. Accordingly, for block 125, the Focus Rank 112 for provider P1 can be the sum of Keyword Count and Keyword Priority for provider P1, which is equal to 10.

Keyword Count can be the number of keywords a provider uses to describe their focus. The more keywords used to describe a provider's focus, the less focused they are overall. For example, a provider may use the words “shoes”, “flipflops”, and “sandals” to describe their focus. As such, the resulting Keyword Count would be 3, as there are three words declared as a focus for the provider. Keyword Priority can be the priority order assigned to a specific keyword for a provider. Using the prioritized list of keywords (“shoes”, “flipflops”, and “sandals”), if “shoes” were the keyword 105 input then the Keyword Priority for shoes would be 1.

Trust Priority (“Tp”) 114 (e.g., trust score) can be used to determine how trustworthy a provider is overall and from the view of a specific consumer. For each provider P1, P2, P3, the Trust Priority for that provider may be derived by multiplying Trust Count (“Tc”) and the sum of matching Trust Factors (“Tf”). In one example, where matching Trust Factor equals 2 and Trust Count equals 1000, then the Trust Priority would be equal 2000. A Trust Factor may be defined by a consumer and supported by (e.g., an attribute of) a provider. Trust Factors are used by the Ranking Apparatus to personalize the consumer's rankings of providers by increasing the rank of providers that support the personal preferences of an individual consumer. For example, a consumer may trust companies that are located in their country of citizenship or where the provider has more than 100,000 consumers trusting them as identified in the Ranking Apparatus. When a Trust Factor matches between a consumer and provider, it may increase the overall value of the Trust Count associated between that consumer and provider by one. Trust Factors may be created by matching reasons for trust set by a consumer and respected (e.g., met) by providers. Trust Count can be the quantitative and qualitative trust for a given provider. In some embodiments, Trust Count may be defined at least in part to include the count of consumers explicitly trusting a provider and the popularity of a provider based on usage. The foregoing are examples of Trust Count and other representations of Trust Count are contemplated and within the scope of the disclosure.

A Trust Factor can be any reason or factor for determining how a consumer and provider would trust each other. For example, a consumer could define that they only want to trust provider's having certain attributes. As a more specific example, a consumer may only want to trust provider's having more than 1,000,000 people trusting the provider or only provider's with less than 10 keywords describing their focus. If a consumer defines a Trust Factor and a provider supports that Trust Factor, then Trust Count is increased by one and the ranking for that provider is increased for that consumer. Ideally, Trust Factors are quantifiable and controlled by the Ranking Apparatus; however, consumers can validate that a provider supports (e.g., has as an attribute) a particular Trust Factor and by doing so can help in determining the compliance of a Trust Factor for a provider without the provider being involved.

Trust Count can be the measure of trust for a given provider. For example, the Trust Count of a provider could be the number of consumers that trust that provider. Alternatively, Trust Count could be the order for a given provider in a popularity database based on the number of clicks for that domain in search queries. Trust Count could be any measure which quantifies how and/or to what degree consumers trust a given provider.

For the purpose of simplicity, in FIG. 1 the Trust Factor and Trust Count are set to 1 for each of the providers P1, P2, P3. In the example of FIG. 1 regarding a keyword K schematically represented by block 105, provider P1 is associated with a Focus Rank of 13 and a Trust Priority of 2; provider P2 is associated a Focus Rank of 6 and a Trust Priority of 2; and provider P3 is associated with a Focus Rank of 27 and a Trust Priority of 2. In this regard, in their respective groups or sets of keywords, each of the providers P1, P2, P3 have both specified the keyword K schematically represented by block 105, and specified the Keyword Priority (“Kp”) for the keyword K schematically represented by block 105 to describe their degree of focus as it pertains to the keyword K schematically represented by block 105. In this regard, provider P2 has more focus and trust as it relates to the keyword K schematically represented by block 105 than the providers P1, P3 due to provider P2 assigning the keyword K the highest Keyword Priority (Kp=1) and provider P2 having the lowest Keyword Count (Kc=5). Accordingly, with respect to the keyword K schematically represented by block 105, provider rank 103 for the provider P1, P2, P3 respectively are two, one and three. In this regard, for a given keyword, providers with a higher Keyword Priority and a low Keyword Count may be considered more focused than providers who describe themselves with a lower Keyword Priority and greater Keyword Count. In this example, when it is indicated that Keyword Priority is higher, it is meant that it is ranked in the highest position or the number one position as it relates to Keyword Count.

The factors (e.g., Keyword Count, Keyword Priority, Trust Factors and Trust Count) associated with FIG. 1 are provided by way of example, and not for purposes of limiting the scope of this disclosure. For example, additional and/or different factors may be associated with the Providers P1, P2, P3. As such, the Focus Rank and Trust Priority scores may be comprised of other factors which may, for example, be used to determine the priority focus of the keyword at block 105 for a given provider. Providers with a higher Trust Priority may be allowed to have larger Keyword Counts with lower keyword priorities without critically impacting their provider rank 103 for a specific keyword when compared to other providers which are more focused and specialized. Additionally, in some embodiments, a provider may be assigned a higher rank overall if the provider has matching Trust Factors which are important to consumers.

Trust Factors can describe what can be important to a consumer. For example, a Trust Factor may include a consumer defined Trust Factor where the consumer only trusts companies with one million or more people trusting the providers domain name, trust companies organized in their country of citizenship, trust companies which do not collect personal data, trust a domain name based on a level of trust, and/or other similar factors which allow consumers to trust which providers they interact with. Trust Factors are important to consumers because they allow consumers to personalize a ranked list providers and their content higher by describing the interaction rules (their Trust Factors) for ranking content providers higher without manually having to figure out which ones meet their needs. Further, Trust Factors can help consumers ensure that their content interaction does not unintentionally give away information which is personal and private. When consumers enable Trust Factors, it will seek to cause providers to change their behaviors to match the consumers' preference. Said in another way, Trust Factors seek to empower consumers with a way to influence providers by sorting trusted providers higher and by limiting their personal view of the Internet to providers they trust. This physically reduces the amount of data that would otherwise be transferred between computing devices and presented in a link that a consumer may click on to only realize the information associated therewith is irrelevant to their information search. By supporting (e.g., having attributes that satisfy) a consumers Trust Factors, providers will be more visible in the ranking of that keyword context for the specific consumer. In the context of privacy and terms of use, Trust Factors enable a consumer to create a personalized privacy statement. A privacy statement allows a consumer to define how they see the world in a single place and it allows them to explicitly override the default terms of use and/or privacy statement defined by a provider. This helps to ensure a provider can comply with the consumers Trust Factors rather than each consumer having to interpret and understand each provider's privacy and terms of use policy. One skilled in the art will recognize that this is just one example of Trust Factors and there are many other Trust Factors which are important to consumers and providers, and such other Trust Factors are within the scope of this disclosure.

In accordance with some embodiments, the scoring and ranking of a provider may be defined based on a combination of one or more of the provider's maturity, number of providers included in a keyword focus query, the count of keywords defined by a provider, the priority specified for each defined keyword, the degree or count of popularity or trust, and the Trust Factors matched between a consumer and provider. As a particular example of a mathematical operation that may be part of a computer-implemented method that may be carried out by the Ranking Apparatus, the score or focus ranking (“Fr”) provided by the Ranking Apparatus for a given keyword query for a provider (“KP”) may be defined as specified in the following equation:

$$Fr ( KP ) = {log}_{Pc} ( Tm ) + \frac{( Tc * CTc ) * ( ( Tf + 1 ) * CTf ) )}{( Kc * CKc ) + ( Kp * CKp )} \qquad [ 1 ]$$

Provider Count (“Pc”) in Equation 1 may be defined as the total number of providers associated with a specific keyword query, or more specifically the total number of providers whose set of one or more keywords includes the at least one keyword that is the subject of the keyword query. Trust Maturity (“Tm”) in Equation 1 may be defined as a measure of a relationship in time and quality for a provider. For example, Trust Maturity may be used as a tie breaker when the Trust Priority of two or more providers have an equal ranking after their ranking is determined. The optional Trust Maturity variable ensures that the provider which is most trusted will appear at the top of the ranked list of providers when a tie occurs. In some embodiments, Trust Maturity may be defined based at least in part on the order in which a provider signed up for the service provided by the Ranking Apparatus. In this example, if the ranking provided by the Ranking Apparatus is found to be equal for two or more providers for a given keyword context, then the length of time those providers have been in the system provided by the Ranking Apparatus will be determinative, so that the provider that has been in the system provided by the Ranking Apparatus the longest will be ranked highest. More generally, the length of time that providers have been in the system provided by the Ranking Apparatus may be a factor that influences the final rankings, so that providers who have been known longer or are considered more mature are ranked higher than other providers.

In some embodiments, Trust Maturity may be further refined based on the Provider Count in the context of a specific keyword. Provider Count or the number of providers included in a ranking provided by the Ranking Apparatus in a keyword query may be used to reduce the influence of Trust Maturity. This seeks to ensure that the method used to force the ranking of all providers does not significantly influence the overall ranking. The number of providers who relate to a specific keyword determines the overall focus of all providers universally for the specific keyword. It also determines the keyword's commonality as compared to other words, as keywords which are more frequently used are also more common. In this example, Provider Count and Trust Maturity may be used as a tie breaker when the ranking value provided by the Ranking Apparatus for one or more providers are equal when determined based upon Equation 1.

At least partially reiterating from above and for example, Trust Count (“Tc”) for Equation 1 may be defined as the number of consumers who trust a particular provider. In Equation 1, a weighting coefficient designated by “CTc” may be defined as a coefficient representing the weight assigned to Trust Count as compared to other factors. Further, in some embodiments, Trust Count may be calculated based on a provider popularity ranking Popularity ranking can be the popularity for a given provider based on usage in an external or related system. Trust Count can also be derived based on an explicit or implicit trust of a provider based on the same or another system which provides the count of consumers who trust a particular domain name and their relevant trust of providers. For example, in an external system, consumers could trust a provider with full, partial, or no trust which could then be assigned numbers based on the degree of trust. In this example, the degree of trust is also relevant and would be considered as part of the determination of Trust Count. At least partially reiterating from above and for example, Trust Factor (“Tf”) for Equation 1 may represent qualitative and/or quantitative measure of a consumers, providers, or systems preference for providers which they prefer to interact with. In Equation 1, a weighting coefficient designated by “CTf” may be defined as a coefficient representing the weight assigned to Trust Factor. One example of a Trust Factor can be whether a provider collects personal data. If a provider does not collect personal data and the consumer specifies a trust for providers that do not collect data, then the Trust Factor count or Trust Count for that provider may be increased by 1. Examples of other Trust Factors that may be used in addition to or in lieu of whether a provider collects personal data may include: the number of consumers who trust a provider, the number of keywords a provider defines, if the provider is a public company, if the provider is not included in a blocked list, where the provider is headquartered and many other factors that may be indicative of the trustworthiness of a provider. In some embodiments, each matching Trust Factor between a consumer and provider may increase the Trust Factor count or Trust Count, such as by one or some other value. Trust Factors may be applied, such as in Equation 1, as a multiplier to a provider's Trust Count for a specific keyword and/or a specific consumer.

At least partially reiterating from above and for example, Keyword Count (“Kc”) for Equation 1 may be defined as the total number of keywords specified by a provider or body of consumers indicating the content focus for a provider. In Equation 1, a weighting coefficient designated by “CKc” may be a coefficient representing the weight assigned to Keyword Count. The coefficient values (e.g., CKc) in Equation 1 may be assigned values that collectively equal one when summed. This seeks to ensure that the inputs to Equation 1 are proportionally distributed to control which variable influences the results of the ranking provided by the Ranking Apparatus. For example, Keyword Count can be determined based at least in part on a count of the keywords listed in the HTML keywords meta tag of providers, Keyword Priority (“Kp”) may be the priority assigned to each keyword by a provider for indicating their specific content focus, and CKp may be a coefficient representing the weight assigned to Keyword Priority. CKp could be personally defined by the consumer or by the Ranking Apparatus to prioritize Keyword Priority as being more or less important than other factors. For example, a consumer may decide that Keyword Priority is the most important factor in the ranking provided by the Ranking Apparatus, and the consumer could set the CKp coefficient higher than the other coefficients.

In some embodiments, Keyword Priority for a provider may be automatically determined by the Ranking Apparatus by using the position of words listed in the provider's HTML keywords meta-tag or a similar existing list from left to right. Thus, for example, if a provider's keyword meta-tag is set to {clothing, suits, dress, womensclothing} then clothing may be defined as the first priority keyword, suits as the second priority keyword, dress as the third priority keyword, and womensclothing as the fourth priority keyword, with a total of four keywords. Keyword Priority may additionally or alternatively be determined based on the ordering, arrangement, ordering and arrangement, or font sizes and styles used by links within a website, suggestions of keywords, and keyword metadata for providers by consumers, or an explicit priority ranking that may be defined and provided by the provider or consumer.

In some embodiments, a Keyword Priority for a keyword and a low Keyword Count may be considered to identify the provider as being focused and specialized in the associated keyword area. Furthermore, it should be recognized that new providers can be associated with the same content and/or web server for the purpose of inaccurately influencing their ranking provided by the Ranking Apparatus. Specifically, a provider could register multiple domain names or email addresses and assign differing keyword, Keyword Counts, and Keyword Priorities but point the domains at the same web pages or content. In a manner that seeks to prevent this, some examples include a Trust Priority (or the combination of the Trust Count factored by the matching Trust Factor Multiplier based on the number of consumers who trust a provider which is then divided by the Focus Rank or Keyword Count plus the Keyword Priority in accordance with Equation 1). This seeks to ensure that domains and/or other identifiers must be branded and marketed such that consumers are required to trust the content in addition to the provider to ensure that high quality providers and content will be found by others. This may encourage providers to market and brand their information content and products under a single Internet domain name, email address, or other identifier rather than through the use of multiple domain names and/or multiple email addresses to describe the same content.

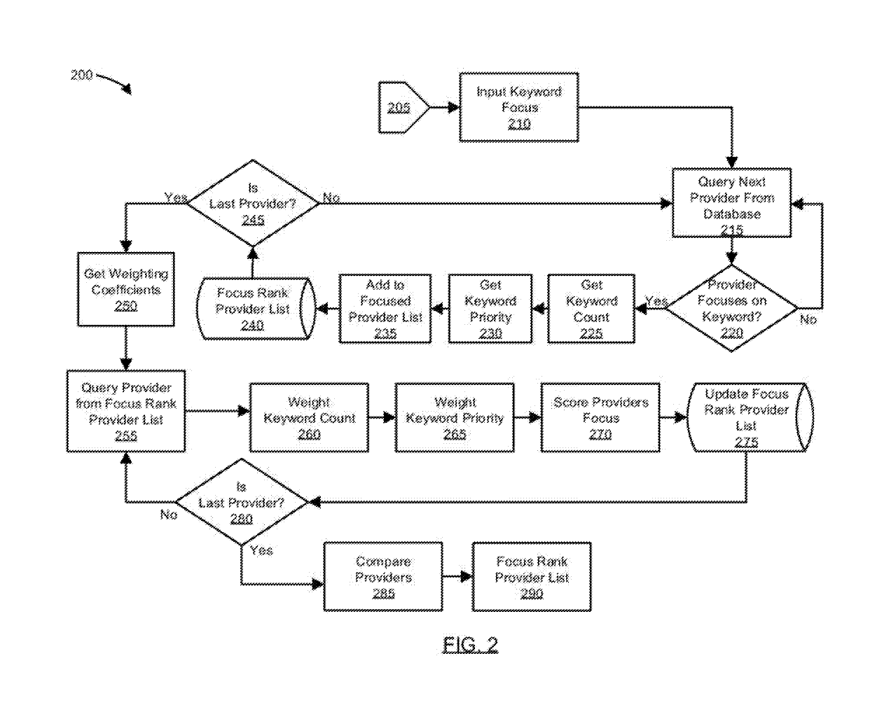

FIG. 2 illustrates an example of a computer-implemented method 200 by which the Ranking Apparatus may operate to transform search results as a result of being configured to determine how providers focused on a specific keyword are ranked based upon their Focus Rank (e.g., focus score), in accordance with the exemplary embodiment. Starting with block 205, an input is sent to and received by the Ranking Apparatus. The input may comprise one or more keywords that may be sent, for example and not for the purpose of limiting the scope of this disclosure, from a web browser of a computerized device of a consumer as part of a keyword search query directed to the Internet. Block 210 schematically illustrates the input received at block 205, wherein the input may be, for example, a keyword or keyword pair, or more generally at least one keyword. The input schematically illustrated by block 210 may be referred to as the Input Keyword Focus or keyword in focus, and this input may be received from any suitable source. Processing control is passed to block 215. At block 215, the keyword represented by block 210 is used as a parameter to query for providers, such as a query for providers of websites, a query for a list of providers such as from a database, or one or more queries for suitable providers from any other suitable locations. The query associated with block 215 may return an unranked list of providers associated with the keyword represented by block 210. In some embodiments, a provider is recognized as a domain name, while in other embodiments the provider may be recognized as an email address, and in some embodiments providers may be recognized as domain names, email addresses and/or in any other suitable manner. Processing control is transferred to block 220. For each provider returned in block 215 a decision is made at block 220 to determine if the current provider is focused on the keyword represented by block 210. This physically removes providers, and subsequently their related content, which are not focused on block 210 and thereby reduces user input required to navigate through search result links that are irrelevant to block 210. For example, a provider may be focused on or associated with the keyword represented by block 210 when the keyword represented by block 210 is included in a set of one more keywords associated with the provider. If the provider is not associated with the keyword represented by block 210, then processing control is passed back to block 215 where the next provider is retrieved. If the provider is associated with the current keyword represented by block 210, then processing control is passed to block 225.

At block 225, the Keyword Count for the current provider is determined (e.g., retrieved). Processing control is transferred from block 225 to block 230. At block 230 the priority number assigned to the keyword represented by block 210 for the current provider is determined (e.g., retrieved). These variables from blocks 225, 230 may be stored in computer memory, a database, or the like, and at block 235 the variables originating at blocks 225, 230 may be retrieved from memory, the database, or the like, and stored in a list of providers in association with the relevant provider name, wherein the list of providers referred to with reference to block 235 is schematically illustrated by block 240 and is typically stored in a database. The list of providers schematically illustrated by block 240 may be referred to as a Focus Rank Provider List. Processing control is then passed to block 245 to determine if the last potentially relevant provider has been considered with respect to blocks 215 through 235. If the last potentially relevant provider has not been considered, then the next provider is queried from the database, or any other suitable location, at block 215 and the steps repeat. If the last potentially relevant provider has been considered, then the processing control is passed from block 245 to block 250. In the exemplary embodiment, the providers included in the Focus Rank Provider List schematically illustrated by block 240 is a subset of a plurality of providers, wherein for each provider of the subset, the keyword represented by block 210 is included in the set of one more keywords associated with the provider; and for each other provider of the plurality of providers, the keyword represented by block 210 is not included in the set of one more keywords associated with the provider. In this regard, one aspect of this disclosure is the provision of a computer-implemented method for at least scoring a subset of information providers, wherein the subset of information providers is a subset of a plurality of information providers, a set of one or more keywords is associated with each information provider of the subset of information providers, and the computer-implemented method comprises receiving at least one keyword; and identifying the subset of information providers from the plurality of information providers, wherein for each information provider of the subset of information providers, the set of one or more keywords associated with the information provider includes the at least one keyword.

At block 250, the weighting coefficient values (e.g., CKc and CKp) are retrieved for the Keyword Count and Keyword Priority. At block 255, the Focus Rank Provider List schematically illustrated by block 240 is queried for the first provider included in the list along with its Keyword Count and Keyword Priority. Keyword Count and Keyword Priority may then be modified at blocks 260, 265 with a relative weighting according to their respective coefficients retrieved in block 250 to create a weighted Keyword Count and Keyword Priority. Next, at block 270 the weighted Keyword Count from block 260 and Keyword Priority from block 265 are added together to create a Focus Rank (e.g., focus score) which is stored in computer memory, the database, or the like. At block 275 the Focus Rank Provider List schematically illustrated by block 240 is updated with the Focus Rank for the current provider.

Processing control is passed to block 280. At block 280 a check is performed to determine if this is the last provider in the query. If this is not the last provider, then at block 255 the next provider is queried from the database (e.g., from the Focus Rank Provider List schematically illustrated by block 240) and the relevant steps are repeated. If this is the last provider from the Focus Rank Provider List schematically illustrated by block 240, then at block 285 the providers in the Focus Rank Provider List schematically illustrated by block 240 are compared and ranked based on their Focus Rank (e.g., focus score), wherein the providers with a lower Focus Rank are considered to be more focused and ranked higher, whereas providers with a higher Focus Rank are considered less focused and ranked lower. Processing control is transferred to block 290. At block 290, the Focus Rank Provider List schematically illustrated by block 240 is updated to reflect the ranking of block 285.

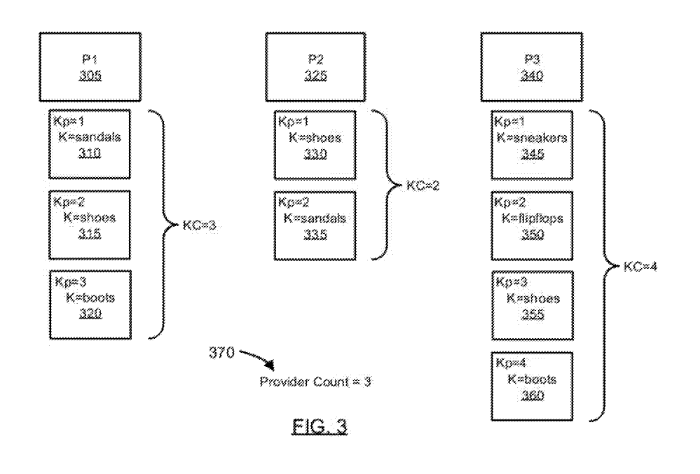

FIG. 3 is a block diagram including information that may be used, in accordance with one example, for determining the Focus Rank (e.g., focus score) for providers, and ranking the providers based upon their Focus Ranks. In FIG. 3, blocks 305, 325, 340 are illustrative of data for at least identifying a plurality or subset of providers, which may be designated as providers P1, P2, P3, respectively. Blocks 310 through 360 respectively represent the providers' P1, P2, P3 prioritized keyword lists which identify their content focus. Stated differently, Blocks 310 through 360 schematically illustrate sets of keywords and associated data that are respectively associated with the providers P1, P2, P3. Blocks 310, 315, 320 schematically represent the keyword list or set of keywords for provider P1. Blocks 330, 335 schematically represent the keyword list or set of keywords for provider P2. Blocks 345, 350, 355, 360 schematically represent the keyword list or set of keywords for provider P3. More specifically, the provider P1 has three keywords (“K”) in its set of one or more keywords, where block 310 represents the first priority keyword, block 315 represents the second priority keyword, and block 320 represents the third priority keyword. The provider P2 has defined two keywords in its set of one or more keywords, where block 330 represents the first priority keyword, and block 335 represents the second priority word. The provider P3 has defined four keywords in its set of one or more keywords, where block 345 represents the first priority keyword, block 350 represents the second priority keyword, block 355 represents the third priority keyword, and block 360 represents the fourth priority keyword.

As shown in FIG. 3, provider P1 has a greater number of keywords than provider P2 and less keywords than provider P3. Provider P1 has assigned “shoes” a Keyword Priority (“Kp”) of two and has a total Keyword Count (“Kc”) of three. Provider P2 has assigned “shoes” a Keyword Priority of one and has a total Keyword Count of two. Provider P3 has assigned “shoes” a Keyword Priority of three and has a total Keyword Count of four. In the example of FIG. 3, all three providers P1, P2, P3 have focused on the keyword “shoes” and assigned a Keyword Priority to indicate their focus on the keyword “shoes”. As designated at reference numeral 370 in FIG. 3, the Provider Count (“Pc”) in the example of FIG. 3 is equal to three. The example of FIG. 3 does not include the Trust Maturity or Trust Priority of any of the providers. As such, for Equation 1 each of Trust Maturity, Trust Count, and Trust Factor are equal to one in the example of FIG. 3. For simplicity in the example of FIG. 3, each of the coefficient weightings CKc, CKp, CTc, and CTf is set equal to 0.25 so as to assign an equal weighting to each variable. Using Equation 1: for provider P1, Fr(shoes,P1)=log₃(1)+(((1*0.25)*(1*1)*0.25)/((3*0.25)+(2*0.25))) resulting in a Focus Rank of 0.05; for provider P2, Fr(shoes,P2)=log₃(1)+(((1*0.25)*(1*0.25)*0.25)/((2*0.25)+(1*0.25))) resulting in a Focus Rank of 0.083, and for provider P3, Fr(shoes,P3)=log₃(1)+(((1*0.25)*(1*1)*0.25)/((4*0.25)+(3*0.25))) resulting in a Focus Rank of 0.035. In this example, a higher Focus Rank value represents the provider with the most focus for the keyword “shoes”. Since provider P2 has fewer keywords and has prioritized the “shoes” keyword as its highest priority, its Focus Rank results is the highest number when compared to the other providers P1, P3. Additionally, the provider P1 is ranked second and the provider P3 is ranked third.

Organizing providers by their focus and Keyword Priority seeks to rank providers by specialization. Further, this method as part of an overall system helps to ensure that no single provider can physically hold the highest Focus Rank for every keyword context. Organization by content focus/specialization results in a higher probability of accurate content to reduce the likelihood of brands or people misleading others in an effort to attract them to site content, this (1) reduces or eliminates the benefit to hackers that seek to modify websites without permission for the purpose optimizing search engine results, (2) reduces misdirection or unnecessary page loads to improve data privacy, and by eliminating irrelevant providers (3) significantly reduces the physical bytes transferred between computer devices when consumers are searching. In one aspect of the present disclosure, the purpose of assigning priority to each providers' keyword list is to encourage focused and trustworthy content. By ensuring the providers are ranked based upon their focus, it allows consumers to find and filter content quickly and accurately, for example. The values of Trust Count, Trust Factor, Keyword Count, and Keyword Priority may be assigned differing coefficients to represent the relative weighting of each input. In some embodiments, the Keyword Priority and the Keyword Count may be considered more important than the Trust Count or number of consumers trusting a provider. For this reason, in some embodiments the coefficient weightings CKc and CKp may be set to higher values than the coefficient weightings CTf and CTc.

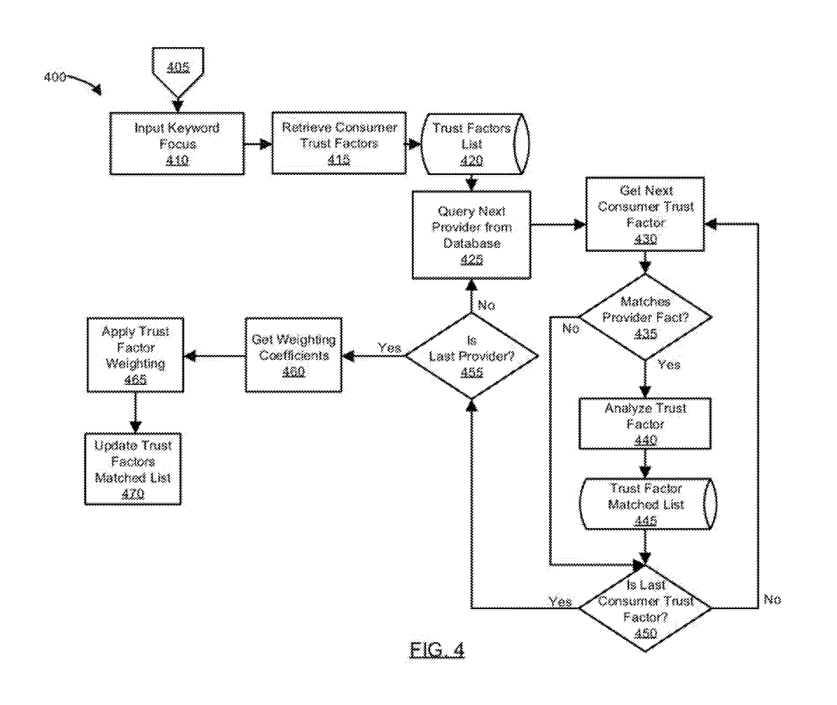

FIG. 4 illustrates an example of a computer-implemented method 400 by which the Ranking Apparatus may perform operations with regard to Trust Factors, for scoring purposes, wherein the Trust Factors may influence the ranking of providers based on consumer's individual preferences for trust, in accordance with the exemplary embodiment. Starting with block 405, an input is sent to and received by the Ranking Apparatus. The input may comprise one or more keywords that may be sent, for example and not for the purpose of limiting the scope of this disclosure, from a web browser of a computerized device of a consumer as part of a keyword search query directed to the Internet. Block 410 schematically illustrates the input received at block 405, wherein the input may be, for example, a keyword or keyword pair, or more generally at least one keyword. The input schematically illustrated by Block 410 may be referred to as the Input Keyword Focus or keyword in focus, and this input may be received from any suitable source.

Processing control is passed to block 415. At block 415, Trust Factors are retrieved for the current consumer that initiated the present query, and the current consumer's Trust Factors may be written to a Trust Factors List that is schematically illustrated by block 420. Processing control is transferred to block 425. At block 425, the keyword represented by block 410 is used as a parameter to query for providers, such as a query for providers of websites, a query for a list of providers such as from a database, or one or more queries for suitable providers from any other suitable locations. For example, the query at block 425 may be substantially like the query at block 215 of FIG. 2, the query at block 425 may include the operations of both of blocks 215 and 220 of FIG. 2, and/or the computer-implemented method 400 and the computer-implemented method 200 (FIG. 2) or portions thereof may be substantially combined with one another.

Processing control is transferred to block 430. At block 430, the Ranking Apparatus queries consumer Trust Factors, such as from the Trust Factors List schematically represented by block 420, for a consumer Trust Factor for the current consumer. Processing control is transferred to block 435, where a comparison is made between the consumer Trust Factor most recently retrieved at block 430 and trust facts (e.g., attributes, factors, or the like) for the provider most recently retrieved at block 425. If the consumer Trust Factor does not match with a provider fact then processing control is sent to block 450 to check for the next Trust Factor, if any. If it is determined at block 450 that the last Trust Factor has not been evaluated in the present pass through the loop, then processing control is passed to block 430 and the relevant steps are repeated for the next consumer Trust Factor.

If a match is identified at block 435, then processing control is passed to block 440 which analyzes the subject Trust Factor. As an example, for a consumer Trust Factor “provider is trusted by more than 10,000 consumers” being analyzed at block 440, the analysis may comprise comparing the subject consumers Trust Factor to the known or discoverable facts about the provider. Through comparison, if the provider has greater than 10,000 consumers trusting it, then the provider is added to the Trust Factors Matched List represented by block 445, and the subject provider's Trust Factor match value is increased by one. If the provider has less than or equal to 10,000 consumers trusting the provider, then the subject provider's Trust Factor match value is not increased by one.

Processing control is transferred to block 450. At block 450, a determination is made as to whether the last consumer Trust Factor has been processed through the most recent loop. If not, then processing control is passed to block 430 and the relevant steps are repeated for the next Trust Factor. If it is determined at block 450 that the last Trust Factor has been processed through the most recent loop, then processing control is passed to block 455 which determines if the present provider is the last provider. If the present provider is not the last provider, then processing control is passed to block 425 and the next provider is retrieved and the relevant steps are repeated. If it is determined at block 455 that the present provider is the last provider, then processing control is passed to block 460 which retrieves the Trust Factor weighting coefficient (“CTf”) and stores it in memory, the database, or the like. Then processing control is transferred to block 465. At block 465, for each provider in the Trust Factors Matched List represented by block 445, the total number of Trust Factors matches is multiplied by the weighting coefficient retrieved at block 460. Then processing control is transferred to block 470, wherein the Trust Factors Matched List represented by block 445 us updated with the information from block 460. There are many examples of Trust Factors, and by incorporating Trust Factors into the ranking providers a way is created for consumers to build digital borders where the most trustworthy providers are ranked higher and thereby made more visible to the consumer.

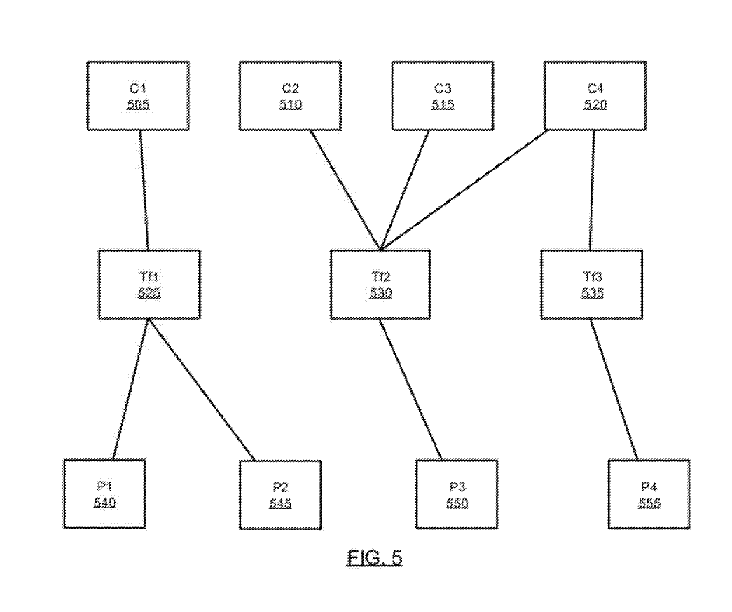

FIG. 5 is a block diagram including information that may be used, in accordance with an example, for measuring focus and trust ranking to determine the best providers based on a consumer's Trust Factors. In FIG. 5, there are four consumers C1, C2, C3, C4 schematically represented by blocks 505, 510, 515, 520; three Trust Factors Tf1, Tf2, Tf3 schematically represented by blocks 525, 530, 535; and four providers P1, P2, P3, P4 schematically represented by blocks 540, 545, 550, 555. FIG. 5 illustrates the relationship between a consumer's Trust Factor preferences relative to provider facts (e.g., attributes) which support specific Trust Factors. In the example of FIG. 5, consumer C1 has one Trust Factor Tf1 that is matched to two providers P1, P2. Consumer C2 has one Trust Factor Tf2 that is matched to one provider P3. Further, in the example of FIG. 5, consumer C3 has one Trust Factor Tf2 that is matched to one provider P3. Consumer C4 has two Trust Factors Tf2, Tf3 that are respectively matched to two providers P3, P4. Trust Factors may be provided by consumers and/or providers. A Trust Factor defined by a consumer may match between zero or more providers, where each match may multiply or add to the Trust Count of a provider to increase their ranking and improve visibility. There are many factors related to trust that each individual consumer may have a different personal view for what determines trust. In some embodiments, consumers and/or providers may set a preference for trusting and/or complying with specific Trust Factors. Analysis, approved third party data sources, provider facts, a group of consumers, or any combination of these or other suitable means will determine whether or not a provider matches the trust requirements associated with the Trust Factors. By default, consumers trust the providers based on a subjective level of trust and may also initially trust providers based on non-validated or qualitative Trust Factors that work off of an honor system until the community or other review and/or analysis determines that the trust factor is valid for a provider. When a provider is caught being dishonest, the provider's Trust Factor Multiplier is negatively impacted for a period of time and their visibility is decreased. In some embodiments, consumers and providers can also (e.g., optionally) prioritize the relative importance of each Trust Factor. For example, a consumer may decide to give a higher weighting to a Trust Factor which requires the provider to be headquartered in their citizenship country. As such, if a provider matches this Trust Factor then the consumer may give the matching provider a 2× multiplier instead of the default of 1×. As an illustrative example using Trust Factors in the context of FIG. 5, Trust Factor Tf1 could require that “a provider have one million consumers trusting it for navigation”; Trust Factor Tf2 could require that “a provider must not share collected personal data with third parties”; and Trust Factor Tf3 could require that “the provider's Keyword Count should be 10 or less to describe their focus”.

When Trust Factors match between a consumer and provider, the provider's Trust Factor Multiplier may be increased by some factor or value, such as, by way of non-limiting example, one, for each matching Trust Factor. The Trust Factor Multiplier value may be used to increase the relative trust of a provider by multiplying the Trust Factor matches by the Trust Count for each provider. Some embodiments define and match Trust Factors to providers so as to create a more personalized view of the web where consumers can decide the types of providers they want to trust and which they do not. As such, matching Trust Factors may be used to rank one provider higher than another, which in turn can increase the focus and trust ranking for a provider in the context of that consumer. By limiting the visibility of providers based upon their matching the interests of individual consumers, it provides a way for consumers to influence provider/business behavior. Additionally, some types of Trust Factors may facilitate the creation of digital borders which protect consumers from providers that fall outside their comfort zone by ranking matching providers higher. Consumers and providers may be interchangeable as a person or business can be both a consumer and a provider of data.

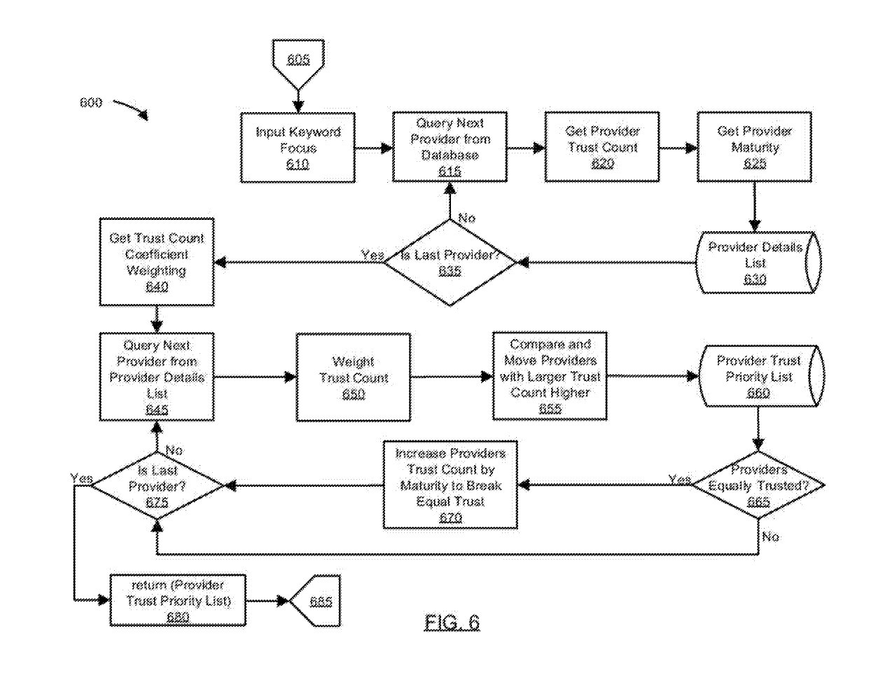

FIG. 6 illustrates an example of a computer-implemented method 600 by which the Ranking Apparatus may rank providers based on individual and/or organizational Trust Count and Trust Maturity. Starting with block 605, an input is sent to and received by the Ranking Apparatus. The input may comprise one or more keywords that may be sent, for example and not for the purpose of limiting the scope of this disclosure, from a web browser of a computerized device of a consumer as part of a keyword search query directed to the Internet. Block 610 schematically illustrates the input received at block 405, wherein the input may be, for example, a keyword or keyword pair, or more generally at least one keyword. The input schematically illustrated by Block 610 may be referred to as the Input Keyword Focus or keyword in focus, and this input may be received from any suitable source.

Processing control is passed to block 615. At block 615, the keyword represented by block 610 is used as a parameter to query for providers, such as a query for providers of websites, a query for a list of providers such as from a database, or one or more queries for suitable providers from any other suitable locations. For example, the query at block 615 may be substantially like the query at block 215 of FIG. 2, the query at block 615 may include the operations of both of blocks 215 and 220 of FIG. 2, and/or the computer-implemented method 600 and the computer-implemented method 200 of FIG. 2 may be substantially combined with one another.

Processing control is transferred to blocks 620 and 625. The values for Trust Count (“Tc”) and Trust Maturity (“Tm”) for the provider identified at the most recent occurrence of block 615 are retrieved at blocks 620 and 625, respectively. The values from the most recent occurrences of the blocks 620, 625 may be stored in association information about the provider identified at the most recent occurrence of block 615 in a list of providers, wherein this list of providers is schematically illustrated by block 630 and may be referred to as a Provider Details List. Processing control is then passed to block 635 to determine if the provider identified at the most recent occurrence of block 615 is the last provider. If it is determined at block 635 that the provider identified at the most recent occurrence of block 615 is not the last provider then the next provider is queried at block 615 and the steps of the relevant loop are repeated. If it is determined at block 635 that the provider identified at the most recent occurrence of block 615 is the last provider, then processing control is passed to block 640.

At block 640, the weighting coefficient for Trust Count (“CTc”) is retrieved and stored in memory, the database, or the like. Next, at block 645, the list of providers schematically illustrated by block 630 is queried for a provider along with its Trust Count values. At block 650, a weighting is applied to the Trust Count by multiplying its value by the weighting coefficient for Trust Count (“CTc”) retrieved at block 640. Processing control is then transferred to block 655. At block 655, the Trust Count for the current provider is compared with each Trust Count in the Providers Details List schematically illustrated by block 630. The current provider is compared with other providers and its rank is moved up until its Trust Count is no longer higher as compared with the other providers in the Providers Details List schematically illustrated by block 630. At block 665, the list of providers in the Providers Details List schematically illustrated by block 630 is checked for providers which have an equal Trust Priority, wherein Trust Priority may be synonymous with Trust Count in this example. If there are no providers with equal Trust Priority or Trust Count, then processing control is transferred to block 675. If there are providers with equal Trust Priority or Trust Count then block 670 adds the Trust Maturity to the analysis for those providers to force the prioritization of the providers such that no two are equal. That is, if there are providers with equal Trust Priority or Trust Count, then the one of those providers with the largest Trust Maturity will rank higher than those with lower Trust Maturity.

Processing control is then transferred to block 675. At block 675 a check is performed to determine if this is the last provider. If there are more providers to be considered then the next provider is retrieved from block 645 and the steps of the loop are repeated. If there are no more providers to be considered then the updated list of providers originally schematically illustrated by block 630 is stored in a database, suitable computer memory, or the like, and the process may end at block 685.

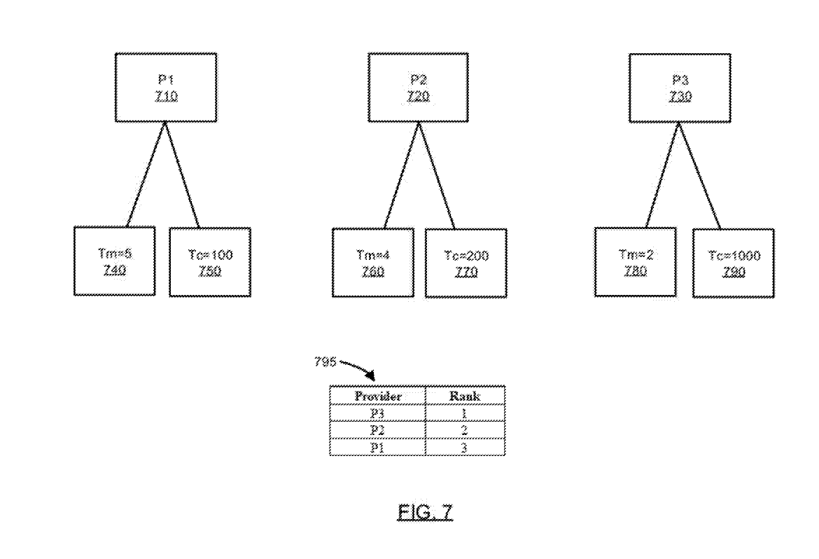

FIG. 7 is a block diagram including information that may be used, in accordance with an example, to illustrated ranking of providers using Trust Priority (“Tp”). In FIG. 7, three providers P1, P2, P3 are schematically represented by blocks 710, 720, 730. Blocks 740, 760, 780 respectively represent the provider's P1, P2, P3 Trust Maturity (“Tm”). Blocks 750, 770, 790 respectively represent the provider's P1, P2, P3 Trust Count (“Tc”). In this regard, FIG. 7 illustrates an example of ranking providers by Trust Priority which is comprised of the Trust Maturity and the Trust Count for providers. In the example of FIG. 7, provider P1 has a Trust Maturity of 5 and a Trust Count of 100; provider P2 has a Trust Maturity of 4 and a Trust Count of 200; and provider P3 has a Trust Maturity of 2 and a Trust Count 1000. As such, the total Provider Count is equal to three providers. In the present example, the coefficient for weighting Trust Count, namely coefficient CTc, is set equal to 1. The equation is as follows:

(PnTp)=log_{Pc}(Tm)+(Tc*CTc)

As an example at least partially illustrated in FIG. 7: provider P1 has been in business for 5 years and provider P1 may be assigned a Trust Maturity (“Tm”) of 5; the total number of consumers trusting provider P1 is 100 and provider P1 may be assigned a Trust Count (“Tc”) of 100; provider P2 has been in business for 4 years and provider P2 may be assigned a Trust Maturity of 4; the total number of consumers trusting provider P2 is 100 and provider P2 may be assigned a Trust Count of 200; provider P3 has been in business for 2 years and provider P3 may be assigned a Trust Maturity of 2; and the total number of consumers trusting provider P3 is 1000 and provider P3 may be assigned a Trust Count of 1000. Using this example and the above equation, provider P1 has a Trust Priority of 1.01, provider P2 has a Trust Priority of 1.15, and provider P3 has a Trust Priority of 1.50. In this illustrative example, the higher number indicates a higher degree of trust for the provider. As illustrated in table 795 of FIG. 7 for this example, provider P3 is the highest ranked provider, followed by provider P2 and provider P1.

Trust Maturity may be used to determine if the focus claimed by a provider is accurate and not misleading. Trust Maturity may be determined based at least in part by one or more of the following: on the amount of time a provider has been known to a system, on the length of time a provider has been in business, the frequency of updates by which the provider keeps their information maintained, timeliness of validation that data has been updated, the accuracy and quality of data facts regarding providers as determined by a crowd of consumers, or any other factor which measures the maturity and trust of a provider. The foregoing examples of Trust Maturity are provided as examples, and not for purposes of limitation, as it is contemplated within the scope of the disclosure that there are many quantifiable attributes that may be considered and contribute to the measure of Trust Maturity.

Trust Count may, for example, be determined based on the number of people who trust the provider, the level of trust that consumers have for a provider, the popularity ranking of a provider, or any combination so as to measure a crowd of consumers' usage of a provider's information and transform the search results based thereon. In some embodiments, when Trust Maturity is measured for a set of providers that describe themselves as focusing on a specific keyword context, a higher ranking may be given to a provider which has a higher Trust Maturity and higher Trust Count relative to other providers.

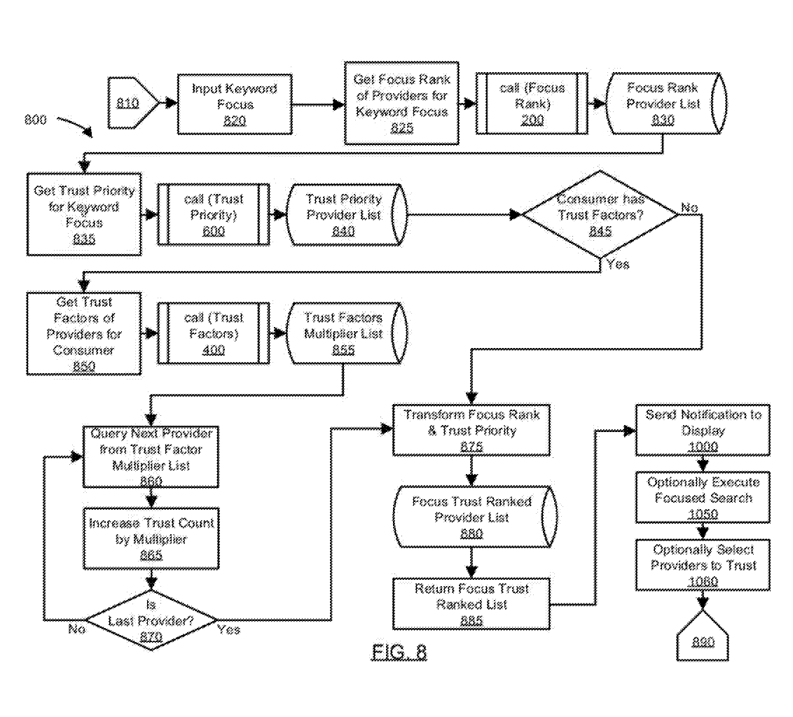

FIG. 8 illustrates an example of an overall computer-implemented method 800 by which the Ranking Apparatus may rank providers, in accordance with the exemplary embodiment. Starting with block 810, an input is sent to and received by the Ranking Apparatus. The input may comprise one or more keywords that may be sent, for example and not for the purpose of limiting the scope of this disclosure, from a web browser of a computerized device of a consumer as part of a keyword search query directed to the Internet. Block 820 schematically illustrates the input received at block 810, wherein the input may be, for example, a keyword or keyword pair, or more generally at least one keyword. The input schematically illustrated by Block 610 may be referred to as the Input Keyword Focus or keyword in focus, and this input may be received from any suitable source.

Several blocks of the computer-implemented method 800 are cooperative for calling a series of other computer-implemented methods, namely the above-discussed Focus Rank Method 200 (FIG. 2), Trust Priority Method 600 (FIG. 6), and Trust Factors Method 400 (FIG. 4), as will be discussed in greater detail below. Block 825 receives the keyword focus 820 and calls the Focus Rank Method 200 (FIG. 2) by passing the keyword focus 820 as a parameter. The result is returned and written to a Focus Rank Provider List database at block 830. Next, the Input Keyword Focus 820 is passed as an input to block 835 which calls the Trust Priority Method 600 (FIG. 6) to retrieve the Trust Priority for the providers associated with the Input Keyword Focus 820. The resulting provider list and detail from method 600 is returned and written to a Trust Priority Provider List 840. Processing control is then passed to block 845 which determines if the consumer has defined Trust Factors. If the consumer has Trust Factors then processing control is passed to block 850 where the Input Keyword Focus 820 and the consumer identity are passed as parameters to the Trust Factors Method 400 (FIG. 4). Method 400 may return a list of providers with Trust Factor Multipliers representing the matching of consumer Trust Factors with a providers support for the Trust Factor. The provider list returned from method 400 is written to the Trust Factors Multiplier List at block 855. At block 860, the Trust Factors Multiplier List 855 is queried for the multiplier which is then applied at block 865 in a way to increase the Trust Count for matching providers in the Trust Priority Provider List 840. Consumers typically will have varying Trust Factors or priorities and all providers may not be relatable to all Trust Factors. In the case that no provider match is found for a Trust Factor, the result is zero matches and the Coefficient Trust Factor value is optionally applied in block 875. At block 870, a check is performed to determine if this is the last provider in the Trust Factors Multiplier List 855. If this is not the last provider then processing control is returned to block 860 and the steps are repeated. If this is the last provider then processing control is transferred to block 875 which transforms the Focus Rank Provider List 830 and the Trust Priority Provider List 840 into a Focus Trust Ranked Provider List 880. As one example and in accordance with Equation 1, block 875 retrieves the Provider Count (“Pc”) and Trust Maturity (“TM”) then applies a log of Provider Count to the Trust Maturity. Provider Count can be the number of providers which focus on a given keyword, such as the Input Keyword Focus 820. Trust Maturity is generally related to the maturity of providers within a system associated with the Ranking Apparatus. Trust Maturity can be used as a tie breaker in the event that one or more providers have an equal ranking. In accordance with one example, no two providers may have equal ranking, even when all other variables are equal.

The Ranking Apparatus then retrieves the Trust Count from the Trust Priority Provider List 840 and also retrieves the Coefficient Trust Factor CTf values for each provider. The Trust Count and Coefficient Trust Factor CTf values for each provider are multiplied to give a weighting. Next the Ranking Apparatus retrieves the Trust Factor count for each provider in the list and adds one to each value. The Trust Factor Count and Coefficient Trust Factor values for each provider are multiplied to give a weighting. The result of Trust Count and the Trust Factor Count are multiplied. The purpose of these two top values is to determine a measure of trust, whether by explicit trust in a system or indirectly through a database containing the popularity of each website. The Trust Factor match counts are used to increase the Trust Count number such that the results are personalized for a specific consumers Trust Factor preferences.

The Ranking Apparatus retrieves the Keyword Count, coefficient for Keyword Count (“CKc”), Keyword Priority, and coefficient for Keyword Priority (“CKp”) from the Focus Rank Provider List 830 for each provider. Block 875 then retrieves Keyword Count then multiplies it by the coefficient for Keyword Count (“CKc”), and also retrieves the Keyword Priority then multiplies it by the coefficient for Keyword Priority (“CKp”) to give an overall weight to each variable. All coefficient values may be changed to influence the overall importance put on each value. In the exemplary embodiment, all coefficient values will add to exactly one. Coefficient values are provided to allow the Ranking Apparatus owner to tune the rank results based on activity within the Ranking Apparatus and to encourage overall fairness. The results of Keyword Count and Keyword Priority are then added. In this example, the purpose of using Keyword Count and Keyword Priority as a denominator is to divide the measure of trust for a provider, in a given keyword focus area, such that the greater number keywords a provider has and the lower they prioritize a keyword in their list (meaning a larger number) the more impact it will have on reducing their overall Trust Count and thereby lower their ranking as compared to other providers. By contrast, the use of this system will rank a provider higher when the keyword in focus is ranked higher (meaning a lower number) by the provider and if they have less keywords to describe their focus. Additionally, this is a system and method for creating fairness in ranking as no one provider can be ranked the highest in every context. It will also be apparent to someone generally skilled in the art that consumers will have more influence over providers' behavior as this system will rank providers higher or lower in a consumer's ranked results based on their matching a Trust Factor defined by the consumer.

The resulting Focus Trust Rank Provider List returned by block 875 is then written to the Focus Trust Ranked Provider List 880 in memory, the database, or the like, and then returned at block 885 to a user or computer 1000 for display. Block 1000 represents the Ranking Apparatus sending a notification to the display or console of the user with the Focus Trust Rank Provider List. Block 1050 represents where a user or program may optionally perform a full text search of the top ranked providers or at block 1060 a user could trust the providers. Block 1060 represents a method for trusting providers returned to the user display so as to add to a trusted list of providers before ending this process at block 890 in accordance with some embodiments.

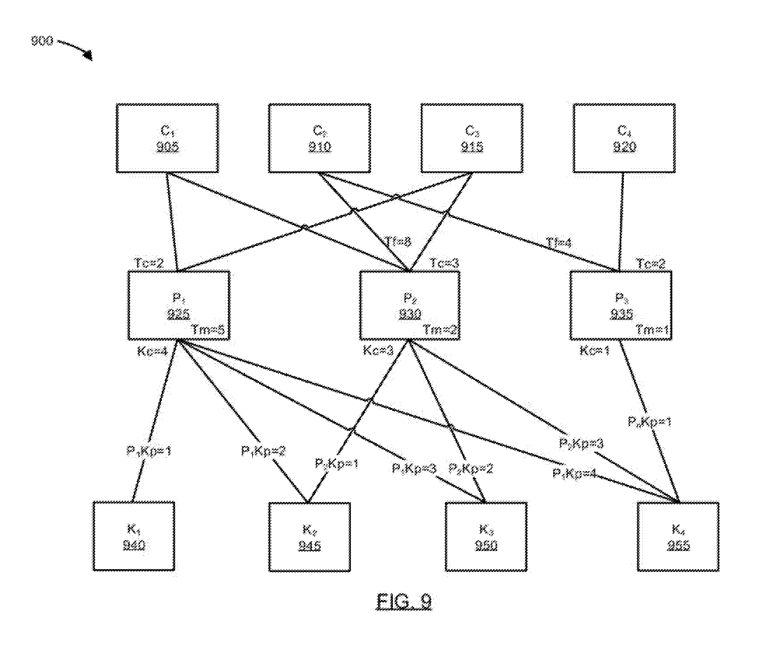

FIG. 9 is a block diagram including information that may be used as part of an example of illustrating operations of the Ranking Apparatus. In the illustrative example of FIG. 9, there are four consumers 905, 910, 915, 920 which have a trust for three providers 925, 930, 935, and there are four keywords 940, 945, 950, 955 prioritized by the four providers. Not all providers 925, 930, 935 focus on each keyword 940, 945, 950, 955. Considering consumer C₂ 910 is seeking the most focused and trusted ranked list of providers for keyword K₄ 955, the focus Trust Priority for each provider may be calculated using Equation 1.

In the example of FIG. 9, the following coefficient weightings are used: CTc=0.25, CTf=0.25, CKc=0.25, CKp=0.25. These coefficient weightings are provided as examples, and not for the purpose of limiting the scope of the present invention. In this regard, coefficient weightings may be varied as desired to control the relative importance of system variables and their overall effect on the system. Consumer C₂ 910 has Trust Factor matches for two providers: P₂ 930 Trust Factor=8 and P₃ 935 Trust Factor=4. Provider P₂ has eight matching Trust Factors with Consumer C₂ 910 and as a result will have a significant ranking advantage in the view of Consumer C₂ 910 over Provider P₃ which has four matching Trust Factors. Provider P₁ 925 has a Trust Count=2, a Keyword Count=4, and Trust Maturity=5. P₂ 930 has a Trust Count=3, a Keyword Count=3, and Trust Maturity=2. Provider P₃ 935 has a Trust Count=2, a Keyword Count=1, and Trust Maturity=1. Provider P₁ 925 defined its focus by prioritizing P₁K₁=1, P₁K₂=2, P₁K₃=3, and P₁K₄=4. Additionally, provider P₂ 930 defined its focus by prioritizing P₂K₂=1, P₂K₃=2, and P₂K₄=3. Provider P₃ 935 has defined its focus by prioritizing P₃K₄=1. As such, given Consumer C₂ 910 and Keyword K₄ 955, the resulting Focus Trust Rank Provider List in the example of FIG. 9 will be determined as: P₂=1.75, P₁=1.52, and P₃=1.25. In this example, P₂ 930 ranked the highest primarily because it has eight matching Trust Factors with the Consumer C₂ 910. P₃ 935 ranked lowest even though it only focused on one keyword with the highest Keyword Priority. Provider P₁ 925 ranked higher than P₃ 935 even though P₃ 935 focused on a single keyword and had 4 matching Trust Factors where P₁ 925 had zero matching Trust Factors. The primary reason for this is that P₁ 925 was more mature in the system and had an equal Trust Count as P₃ 935.

In at least one of the foregoing examples, Trust Maturity has been described as being the number of years a provider has been in the system. Alternatively, the Trust Maturity may be based upon a number of days, a number of months, or any suitable other number(s) for at least partially quantifying the Trust Maturity.

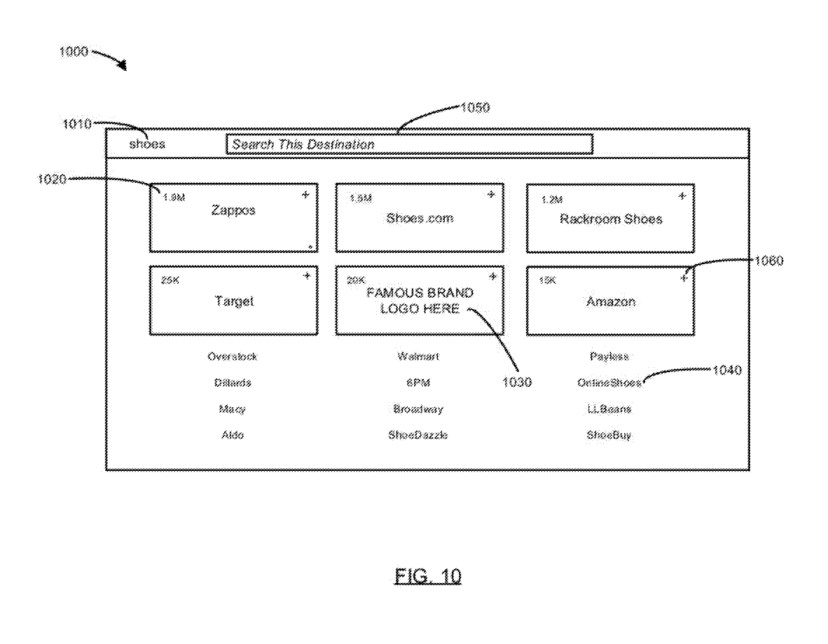

As an illustrative example of a display or visualization of data originating from the Ranking Apparatus, FIG. 10 is schematically represents a screenshot illustrating a destination page in accordance with an example. The destination page 1000 includes a keyword context “shoes” 1010 which is provided as a context for the Ranking Apparatus. This keyword can be passed as a DNS request (e.g., shoes.agingo.com), as an API variable, or typed directly into the destination page. As illustrated in Equation 1, the providers for the keyword context 1010 “shoes” may be queried and ranked according to their focus and trust. Search results including content associated with any and/or all of the content providers is then physically transformed, based on the provider ranking, to organize a personalized view for the consumer such that the most trusted providers are prioritized and generally shown higher among the search results on the search page. In this example, Zappos is ranked highest followed by “shoes.com” and “Rackroom Shoes”. In a second example, the consumer may perform a full text index search of the entire Internet using a traditional search engine and the list of focused and trusted providers for that consumer may be used to transform the search results so that any link with a trusted domain name ranks higher than untrusted domains for that consumer based on the level of trust that consumer has for the domain name.

In FIG. 10, the providers are displayed top to bottom and left to right to indicate their rank in a given keyword context. However, other spatial arrangements and/or notations may be used to visually indicate the rank of providers as contemplated within the scope of the disclosure. Providers with a higher ranking may be provided with additional visibility, information, and features such as the number of people trusting the provider 1020 or a customized logo image 1030; whereas providers with lower rankings could be displayed as text as is “Online Shoes” 1040. A provider, like 1020, may also be provided with an option, such as a plus sign, which allows consumers to easily trust a provider so as to increase the providers Trust Priority through a matching Trust Factor.

The example destination page of FIG. 10 may include a search text box 1050 which may be used to perform a full text private or public search across the providers which are focused on the trusted keyword context “shoes” 1010; thereby creating a vertical search engine for “shoes.” It will be appreciated, however, that FIG. 10 is provided as a non-limiting example of one destination page. In this regard, other destination page formats, as well as alternative channels for communicating search results, provider rankings, and/or the like for a user are within the scope of the disclosure.

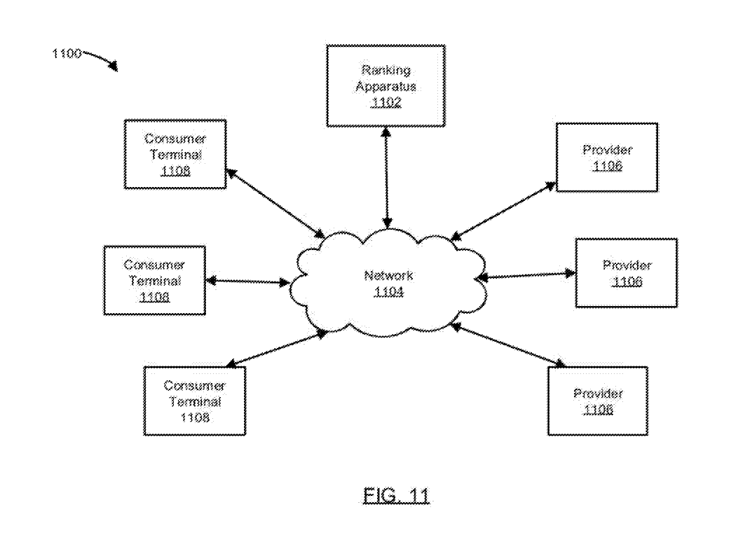

FIG. 11 illustrates an example of the above-discussed Ranking Apparatus, which is designated by numeral 1102 in FIG. 11. In the exemplary embodiment of this disclosure, the Ranking Apparatus 1102 performs each of the above-discussed methods and operations unless indicated differently, or unless it would be understood differently by those of ordinary skill in the art. In this regard and in the exemplary embodiment, the Ranking Apparatus 1102 performs numerous occurrences of the subject methods, loops and operations simultaneously. For example, hundreds, thousands or any other suitable number of the subject occurrences may be performed simultaneously by the Ranking Apparatus 1102.

The Ranking Apparatus 1102 is included in an overall system 1100 The Ranking Apparatus 1102 may be embodied as any suitable computing system, such as, by way of non-limiting example, one or more servers, one or more desktop computers, one or more laptop computers, mobile devices, a cloud computing infrastructure, some combination thereof, or the like, which may be configured to provide a service for providing consumers with a ranked list of providers in response to a search query in accordance with one or more embodiments. The Ranking Apparatus 1102 may, for example, be implemented and maintained by an Internet portal provider, and/or other service that may enable consumers to navigate and search providers accessible over the Internet and/or other network to provide consumers with a rank personalized list of providers based on personal Trust Factors in response to a query. In the exemplary embodiment, the Ranking Apparatus 1102 is configured in a manner that ensures a provider cannot be ranked the highest in every keyword focus area, thereby providing a fairer way to share the visibility with consumers.

The overall system 1100 further includes a network 1104, which may be embodied as any network, or combination of networks, which may enable two or more remote computing devices to communicate with each other, including for purposes of accessing information content that may be accessible from a provider, such as provider 1106. By way of non-limiting example, the network 1104 may, for example, comprise a wireline network, wireless network (e.g., a cellular network, wireless local area network, wireless wide area network, some combination thereof, or the like), or a combination thereof, or may comprise the Internet.

As illustrated, the overall system 1100 may include a plurality of providers 1106. While three such providers 1106 are illustrated by way of example, it will be appreciated that the system 1100 can be scaled to include as many providers as may be accessed over a network, such as the Internet. Each provider 1106 may be implemented as a computing system, such as, by way of non-limiting example, one or more servers, one or more desktop computers, one or more laptop computers, a cloud computing infrastructure, some combination thereof, or the like, which may be configured to provide information content to a computing device over a network, such as via a web page. Each provider 1106 may be associated with an identifier, such as a Uniform Resource Locator (URL) (e.g., a domain name), email address, and/or other identifier that may be used to uniquely identify and access a provider 1106 over the network 1104.

The Ranking Apparatus 1102 may be configured to access and/or communicate with the providers 1106 over the network 1104 to obtain information about the providers 1106 that may be used to rank the providers 1106 for a keyword focus. For example, method 800 (FIG. 8) may be configured to access keyword information, such as prioritized keyword information, that may be provided by a provider 1106 in accordance with various embodiments.

An entity operating and/or otherwise associated with a provider 1106 may register the provider 1106 with the ranking service that may be provided by the Ranking Apparatus 1102 so that the provider 1106 may appear in ranked results that may be provided by the Ranking Apparatus 1102. Additionally or alternatively, in some embodiments, the Ranking Apparatus 1102 may be configured to discover (e.g., crawl) providers 1106 that may be accessed via the network 1104 and add the providers 1106 to a set of providers that may be ranked and returned as results for a search query regardless of whether the provider 1106 has been registered to the Ranking Apparatus.

The overall system 1100 may additionally include a plurality of consumer terminals 1108. A consumer terminal 1108 may be any computing device that may be used by an end consumer to access a network, such as network 1104, and access content from a provider 1106 over the network. By way of non-limiting example, a consumer terminal 1108 may be embodied as a desktop computer, laptop computer, mobile communication device (e.g., a smart phone), tablet computing device, and/or the like.

A consumer may use a consumer terminal 1108 to access a web page, such as a search page, portal, and/or other page that may be provided by the Ranking Apparatus 1102 for a consumer to enter a keyword search query over the network 1104. As such, the consumer may enter a search query including one or more keywords via a consumer terminal and communicate the search query to the Ranking Apparatus 1102 via a query form that may be included on the web page. The Ranking Apparatus 1102 may process the search query and determine a set of search results that may be ranked in accordance with one or more embodiments disclosed herein. The Ranking Apparatus 1102 may further provide the set of search results to the requesting consumer terminal 1108, such as in a search results web page that may be provided to the requesting consumer terminal 1108.

A consumer terminal 1108 may additionally be configured to access a provider 1106 via the network 1104. For example, a consumer terminal 1108 may access a provider 1106 via a link that may be included in a set of search results that may be provided to the consumer terminal 1108 by the Ranking Apparatus 1102 in response to a search query.

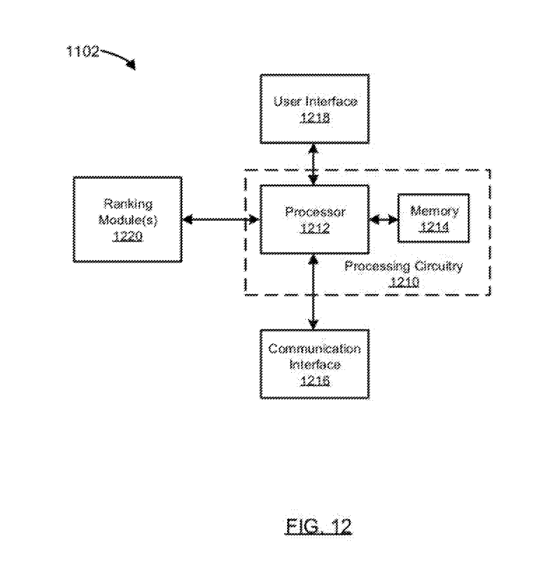

FIG. 12 illustrates a block diagram of the Ranking Apparatus 1102 in accordance with some embodiments. The Ranking Apparatus 1102 may be implemented on any computing device or plurality of computing devices that may form a Ranking Apparatus 1120 in accordance with various embodiments. In this regard, one or more of the components illustrated in and described with respect to FIG. 12 may be implemented on a single computing device, or may be distributed across a plurality of computing devices that may collectively provide functionality of the Ranking Apparatus 1102 in accordance with one or more embodiments.

It will be appreciated that the components, devices or elements illustrated in and described with respect to FIG. 12 below may not be mandatory and thus some may be omitted in certain embodiments. Additionally, some embodiments may include further or different components, devices or elements beyond those illustrated in and described with respect to FIG. 12.

In some embodiments, the Ranking Apparatus 1102 may include processing circuitry 1210 that is configurable to perform actions in accordance with one or more examples disclosed herein. In this regard, the processing circuitry 1210 may be configured to perform and/or control performance of one or more functionalities of the Ranking Apparatus 1102. Thus, the processing circuitry 1210 may be configured to perform data processing, application execution and/or other processing and management services according to one or more embodiments.

In some embodiments, the processing circuitry 1210 may include a processor 1212 and, in some embodiments, such as that illustrated in FIG. 12, may further include memory 1214. The processing circuitry 1210 may be in communication with or otherwise control a communication interface 1216, user interface 1218, and/or ranking module 1220.

The processor 1212 may be embodied in a variety of forms. For example, the processor 1212 may be embodied as various hardware processing means such as a microprocessor, a coprocessor, a controller or various other computing or processing devices including integrated circuits such as, for example, an ASIC (application specific integrated circuit), an FPGA (field programmable gate array), some combination thereof, or the like. Although illustrated as a single processor, it will be appreciated that the processor 1212 may comprise a plurality of processors. The plurality of processors may be in operative communication with each other and may be collectively configured to perform one or more functionalities of the Ranking Apparatus 1102. In some embodiments in which the Ranking Apparatus 1102 is embodied as elements distributed across a plurality of computing devices a plurality of processors, which may collectively form the processor 1212, may be distributed across a plurality of computing devices that may be in operative communication with each other, such as via the network 1104. In some example, the processor 1212 may be configured to execute instructions that may be stored in the memory 1214 or that may be otherwise accessible to the processor 1212. As such, whether configured by hardware or by a combination of hardware and software, the processor 1212 capable of performing operations according to various embodiments while configured accordingly.

In some embodiments, the memory 1214 may include one or more memory devices. Memory 1214 may include fixed and/or removable memory devices. In embodiments which the memory 1214 includes a plurality of memory devices, the plurality of memory devices may be embodied on a single computing device, or may be distributed across a plurality of computing devices, which may collectively provide functionality of the Ranking Apparatus 1102. In some embodiments, the memory 1214 may provide a non-transitory computer-readable storage medium that may store computer program instructions that may be executed by the processor 1212. In this regard, the memory 1214 may be configured to store information, data, applications, instructions and/or the like for enabling the Ranking Apparatus 1102 to carry out various functions in accordance with one or more embodiments. In some embodiments, the memory 1214 may be in communication with one or more of the processor 1212, communication interface 1216, user interface 1218, or ranking module 1220 via a bus(es) for passing information among components of the Ranking Apparatus 1102.

The Ranking Apparatus 1102 may further include a communication interface 1216. The communication interface 1216 may enable the Ranking Apparatus 1102 to receive a signal that may be sent by another computing device, such as over a network. In this regard, the communication interface 1216 may include one or more interface mechanisms for enabling communication with other devices and/or networks. As such, the communication interface 1216 may include, for example, an antenna (or multiple antennas) and supporting hardware and/or software for enabling communications with a wireless communication network (e.g., a cellular network, Wi-Fi, WLAN, and/or the like) and/or a communication modem or other hardware/software for supporting communication via cable, digital subscriber line (DSL), USB, FireWire, Ethernet or other wireline networking methods. Thus, for example, the communication interface 1216 may be configured to enable communication with a provider 1106 over the network 1104. As a further example, the communication interface 1216 may be configured to enable communication with a consumer terminal 1108 via the network 1104 to facilitate receipt of a search query from the consumer terminal 1108 and the provision of a set of search results to the consumer terminal 808 in response to the search query.

In some embodiments, the Ranking Apparatus 1102 may include the user interface 1218. It will be appreciated, however, that in some embodiments, one or more aspects of the user interface 1218 may be omitted, and in some embodiments, the user interface 1218 may be omitted entirely. The user interface 1218 may be in communication with the processing circuitry 1210 to receive an indication of a user input, such as may be provided by a consumer, and/or to provide an audible, visual, mechanical, or other output to a consumer and/or other user. As such, the user interface 1218 may include, for example, a keyboard, a mouse, a joystick, a display, a touch screen display, a microphone, a speaker, one or more biometric input devices (e.g., a visual or sensorial tracing device that may track body part or eye movements), and/or other input/output mechanisms.

The Ranking Apparatus 1102 may further include one or more ranking module 1220. The ranking module 1220 may be embodied as various means, such as circuitry, hardware, a computer program product comprising a computer readable medium (for example, the memory 1214) storing computer readable program instructions that are executable by a processing device (for example, the processor 1212), or some combination thereof. In some embodiments, the processor 1212 (or the processing circuitry 1210) may include, or otherwise control the ranking module 1220. The ranking module 1220 may be configured to rank information providers (e.g., information providers 806) based on focus and/or Trust Factors in accordance with one or more embodiments. For example, the ranking module 1220 of some embodiments may be configured to use Equation 1 to rank information providers.

It will be appreciated that the various aspects, embodiments, implementations and features of the described examples and embodiments may be used separately or in any combination. Various aspects of the described embodiments may be implemented via computer program product implemented via a computer-readable medium, such as memory 1214, storing software and/or firmware, hardware, or a combination of hardware and software.

Many modifications and other embodiments of the inventions set forth herein will come to mind to one skilled in the art to which these inventions pertain having the benefit of the teachings presented in the foregoing descriptions and the associated drawings. Therefore, it is to be understood that the invention should not be limited to the specific embodiments disclosed and that modifications and other embodiments are intended to be included within the scope of the invention. Moreover, although the foregoing descriptions and the associated drawings describe embodiments in the context of certain combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

The above examples are in no way intended to limit the scope of the present invention. It will be understood by those skilled in the art that while the present disclosure has been discussed above with reference to examples of embodiments, various additions, modifications and changes can be made thereto without departing from the spirit and scope of the invention as set forth in the claims

What is claimed is:

1. A computer-implemented method for at least scoring a subset of information providers, wherein the subset of information providers is a subset of a plurality of information providers, a set of one or more keywords is associated with each information provider of the subset of information providers, and the computer-implemented method comprises:
receiving at least one keyword;
identifying the subset of information providers from the plurality of information providers, wherein for each information provider of the subset of information providers, the set of one or more keywords associated with the information provider includes the at least one keyword; and
determining at least one score for each information provider of the subset of information providers, wherein the determining of the at least one score is comprised of
determining a number of keywords included in the set of one or more keywords associated with the information provider, and
determining a priority value of the at least one keyword in the set of one or more keywords associated with the information provider.

2. The computer-implemented method of claim 1, wherein the determining of the priority value is comprised of determining a position of the at least one keyword in the set of one or more keywords associated with the information provider.

3. The computer-implemented method of claim 1, wherein the determining of the priority value of the at least one keyword is comprised of determining the priority value of the at least one keyword in relation to any other keywords included in the set of one or more keywords associated with the information provider.

4. The computer-implemented method of claim 1, wherein the priority value was established by the information provider.

5. The computer-implemented method of claim 1, wherein:
the receiving of the at least one keyword is comprised of receiving the at least one keyword from a web browser by way of the Internet, and
the subset of information providers comprises websites.

6. The computer-implemented method of claim 1, wherein the identifying of the subset of information providers is comprised of determining that the at least one keyword is included in the set of one or more keywords of a provider of the subset of information providers.

7. The computer-implemented method of claim 1, wherein:
the determining of the score for the information provider further comprises performing a mathematical operation upon a plurality of operands; and
the plurality of operands comprises the number of keywords and the priority value.

8. The computer-implemented method of claim 1, further comprising ranking the subset of information providers based at least upon the scores.

9. The computer-implemented method of claim 1, wherein the determining of the at least one score is comprised of:
determining a focus score; and
determining a trust score.

10. The computer-implemented method of claim 1, further comprising receiving at least one trust factor, wherein the determining of the at least one score is further comprised of determining a match between the at least one trust factor and an attribute of the information provider.

11. The computer-implemented method of claim 1, further comprising receiving a plurality of trust factors, wherein the determining of the at least one score is further comprised of counting matches between the plurality of trust factors and attributes of the information provider.

12. The computer-implemented method of claim 1, wherein the determining of the at least one score is further comprised of:
determining a number of matching trust factors associated with the information provider;
determining a trust count associated with the information provider; and
performing at least one mathematical operation upon a plurality of operands, wherein the plurality of operands comprises the number of matching trust factors and the trust count.

13. The computer-implemented method of claim 12, wherein the performing of the at least one mathematical operation further comprises weighting at least one operand of the plurality of operands.

14. The computer-implemented method of claim 13, wherein the weighting is comprised of multiplying by a weighting coefficient.

15. A computer-implemented method for at least scoring a subset of information providers, wherein the subset of information providers is a subset of a plurality of information providers, a set of one or more keywords is associated with each information provider of the subset of information providers, and the computer-implemented method comprises:
receiving at least one keyword;
identifying the subset of information providers from the plurality of information providers, wherein for each information provider of the subset of information providers, the set of one or more keywords associated with the information provider includes the at least one keyword; and
determining at least one score for each information provider of the subset of information providers, wherein the determining of the at least one score is comprised of
determining a consumer trust factor, and
determining whether there is a match between the consumer trust factor and an attribute of the information provider.

16. The computer-implemented method of claim 15, wherein the determining of the at least one score is comprised of:
determining a plurality of consumer trust factors, and
counting matches between the plurality of consumer trust factors and attributes of the information provider.

17. The computer-implemented method of claim 16, wherein the determining of the at least one score is further comprised of multiplying a number of counted matches by a weighting coefficient.

18. A computer-implemented method for at least scoring a subset of information providers, wherein the subset of information providers is a subset of a plurality of information providers, a set of one or more keywords is associated with each information provider of the subset of information providers, and the computer-implemented method comprises:
receiving at least one keyword;
identifying the subset of information providers from the plurality of information providers, wherein for each information provider of the subset of information providers, the set of one or more keywords associated with the information provider includes the at least one keyword; and
determining at least one score for each information provider of the subset of information providers, wherein the determining of the at least one score is comprised of
determining a trust count associated with the information provider,
determining a trust maturity associated with the information provider, and
performing at least one mathematical operation upon a plurality of operands, wherein the plurality of operands comprises at least one of the trust count and the trust maturity.

19. The computer-implemented method of claim 18, wherein the performing of the at least one mathematical operation is comprised of multiplying trust count by a weighting coefficient.

20. The computer-implemented method of claim 18, wherein for any two providers with identical values for trust count, a provider of the two providers with a higher trust maturity is ranked higher than the provider of the two providers with a lower trust maturity.

21. A computer-implemented method including any one or more of the features of claims 1 through 21.

22. An apparatus comprising a processor and a memory storing executable instructions that in response to execution by the processor cause the apparatus to at least:
receive at least one keyword;
identify a subset of information providers from a plurality of information providers, wherein a set of one or more keywords is associated with each information provider of the subset of information providers, and for each information provider of the subset of information providers, the set of one or more keywords associated with the information provider includes the at least one keyword; and
determine at least one score for each information provider of the subset of information providers, wherein the apparatus being configured to determine the at least one score is comprised of the apparatus being configured to
determine a number of keywords included in the set of one or more keywords associated with the information provider, and
determine a priority value of the at least one keyword in the set of one or more keywords associated with the information provider.

23. The apparatus of claim 22, wherein the apparatus is configured to perform any one or more of the operations of claims 1 through 20.

24. An apparatus comprising a processor and a memory storing executable instructions that in response to execution by the processor cause the apparatus to at least:
receive at least one keyword;
identify a subset of information providers from a plurality of information providers, wherein a set of one or more keywords is associated with each information provider of the subset of information providers, and for each information provider of the subset of information providers, the set of one or more keywords associated with the information provider includes the at least one keyword; and
determine at least one score for each information provider of the subset of information providers, wherein the apparatus being configured to determine the at least one score is comprised of the apparatus being configured to
determine a consumer trust factor, and
determine whether there is a match between the consumer trust factor and an attribute of the information provider.

25. The apparatus of claim 24, wherein the apparatus is configured to perform any one or more of the operations of claims 1 through 20.

26. An apparatus comprising a processor and a memory storing executable instructions that in response to execution by the processor cause the apparatus to at least:
receive at least one keyword;
identify a subset of information providers from a plurality of information providers, wherein a set of one or more keywords is associated with each information provider of the subset of information providers, and for each information provider of the subset of information providers, the set of one or more keywords associated with the information provider includes the at least one keyword; and
determine at least one score for each information provider of the subset of information providers, wherein the apparatus being configured to determine the at least one score is comprised of the apparatus being configured to
determine a trust count associated with the information provider,
determine a trust maturity associated with the information provider, and
perform at least one mathematical operation upon a plurality of operands, wherein the plurality of operands comprises at least one of the trust count and the trust maturity.

27. The apparatus of claim 26, wherein the apparatus is configured to perform any one or more of the operations of claims 1 through 20.

28. A computer-readable storage medium that is non-transitory and has computer-readable program code portions stored therein that, in response to execution by a processor, cause an apparatus to at least:
receive at least one keyword;
identify a subset of information providers from a plurality of information providers, wherein a set of one or more keywords is associated with each information provider of the subset of information providers, and for each information provider of the subset of information providers, the set of one or more keywords associated with the information provider includes the at least one keyword; and
determine at least one score for each information provider of the subset of information providers, wherein the computer-readable storage medium being configured to cause the apparatus to determine the at least one score is comprised of the computer-readable storage medium being configured to cause the apparatus to
determine a number of keywords included in the set of one or more keywords associated with the information provider, and
determine a priority value of the at least one keyword in the set of one or more keywords associated with the information provider.

29. The computer-readable storage medium of claim 22, wherein the apparatus is configured to perform any one or more of the operations of claims 1 through 20.

30. A computer-readable storage medium that is non-transitory and has computer-readable program code portions stored therein that, in response to execution by a processor, cause an apparatus to at least:
receive at least one keyword;
identify a subset of information providers from a plurality of information providers, wherein a set of one or more keywords is associated with each information provider of the subset of information providers, and for each information provider of the subset of information providers, the set of one or more keywords associated with the information provider includes the at least one keyword; and
determine at least one score for each information provider of the subset of information providers, wherein the computer-readable storage medium being configured to cause the apparatus to determine the at least one score is comprised of the computer-readable storage medium being configured to cause the apparatus to
determine a consumer trust factor, and
determine whether there is a match between the consumer trust factor and an attribute of the information provider.

31. The computer-readable storage medium of claim 24, wherein the apparatus is configured to perform any one or more of the operations of claims 1 through 20.

32. A computer-readable storage medium that is non-transitory and has computer-readable program code portions stored therein that, in response to execution by a processor, cause an apparatus to at least:
receive at least one keyword;
identify a subset of information providers from a plurality of information providers, wherein a set of one or more keywords is associated with each information provider of the subset of information providers, and for each information provider of the subset of information providers, the set of one or more keywords associated with the information provider includes the at least one keyword; and
determine at least one score for each information provider of the subset of information providers, wherein the computer-readable storage medium being configured to cause the apparatus to determine the at least one score is comprised of the computer-readable storage medium being configured to cause the apparatus to
determine a trust count associated with the information provider,
determine a trust maturity associated with the information provider, and
perform at least one mathematical operation upon a plurality of operands, wherein the plurality of operands comprises at least one of the trust count and the trust maturity.

33. The computer-readable storage medium of claim 26, wherein the apparatus is configured to perform any one or more of the operations of claims 1 through 20.
